(19) United States
(12) Patent Application Publication
(10) Pub. No.: US 2024/0342685 A1
(43) Pub. Date: Oct. 17, 2024

(54) ABSORBENT COMPOUNDS FOR CAPTURING CARBON DIOXIDE

(71) Applicant: The Regents of the University of California, Oakland, CA (US)

(72) Inventors: Anthony Wexler, Davis, CA (US); Keith Bein, Davis, CA (US); Roland Faller, Davis, CA (US); Yihan Huang, Davis, CA (US)

(73) Assignee: The Regents of the University of California, Oakland, CA (US)

(21) Appl. No.: 18/682,813

(22) PCT Filed: Aug. 12, 2022
(86) PCT No.: PCT/US2022/040229

§ 371 Date: Feb. 9, 2024

Related U.S. Application Data
(60) Provisional application No. 63/232,807, filed on Aug. 13, 2021.

(51) Int. Cl. B01J 20/26; B01J 20/34

(52) U.S. Cl. CPC B01J 20/262; B01J 20/3483

(57) ABSTRACT

Absorbent compounds for capturing carbon dioxide (CO₂) having chemical structure represented by Formula I, and compositions thereof, are provided. Embodiments of the present disclosure also describe methods and systems for performing carbon capture using an absorbent compound represented by Formula I for selectively and reversibly capturing carbon dioxide in an absorber. The absorber can optionally be used in conjunction with a stripper to regenerate the absorbent for reuse in the absorber.

### BACKGROUND

Carbon capture and storage (CCS) is considered a critical component of negative emission technologies (NETs) for achieving economy-wide carbon neutrality to mitigate climate change and limit global temperature increase. Burning fuels (e.g., coal, methane, oil, and biomass) by combustion produces a flue gas containing a mixture of gaseous (primarily N₂, CO₂, and H₂O) and particulate matter (PM) components as byproducts. Removal of CO₂ can be undertaken after the standard pollution controls. Yet, the separation of CO₂ from flue gas via CO₂ capture processes is challenging because a high volume of gas must be treated, the CO₂ is dilute, the flue gas is at atmospheric pressure, trace impurities can degrade capture media, and the captured CO₂ must be compressed.

In principle, the gas separation technologies which are currently used in the chemical industry, such as absorption in chemical solvents, can be adapted for post-combustion capture (PCC) of CO₂. A 30 wt % aqueous solution of monoethanolamine (MEA) is considered the benchmark solvent for regenerative chemical absorption-based PCC. The process relies on aqueous phase chemistry between an organic base (amines) and acid gas (CO₂), and is by far the most heavily studied, technologically mature, and economically viable approach.

A major drawback of amine-based systems is that they are energy intensive and thus significantly increase operational costs. The benchmark for new and emerging technologies in terms of cost, energy penalty, CO₂ capture efficiency, and physicochemical properties is MEA. CO₂-loaded MEA solutions are also corrosive to process infrastructure and degrade rapidly. Inevitably, some of these will be lost to the atmosphere where they react to form toxic compounds. In addition, amines contain nitrogen so require nitrogen fixation to manufacture, which is very energy intensive, countering the whole point of carbon capture. MEA also requires high solvent circulation rates, which leads to large equipment sizes and high energy consumption, making the technology capital and operating expenditures unacceptably high. There is a need for cost-effective alternative solvents to reduce the energy penalty and costs of CO₂ capture with absorbents for wide-scale commercial deployment of PCC-based CCS technologies.

### SUMMARY

The present disclosure is predicated on the discovery that bioinspired carbon capture compounds can replace amines in CCS processes and systems. The present inventors built upon a regenerative chemical absorption carbon capture system utilized by a unique group of plants that have adapted to arid climates using a process called Crassulacean Acid Metabolism (CAM) where, to conserve water, the plants uptake CO₂ by opening their stoma at night, rather than the day, and then immediately react it with another compound, phosphoenolpyruvate (PEP), to store the CO₂ overnight. The reaction is reversed in the morning when the sun rises, releasing the CO₂ to participate in photosynthesis. For the present disclosure, PEP serves as a template for designing similar molecules for use as CO₂ solvents with thermochemical properties that address one or more of the drawbacks of MEA, facilitating CCS technologies, including in PCC absorber-stripper systems.

Embodiments of the present disclosure describe PEP variants possessing CO₂ capture activity. The PEP variants described herein can be included in compositions for use as carbon capture solvents and devices/systems configured to capture, and optionally to release, CO₂. Methods of capturing CO₂, including contacting a CO₂-containing gas stream (e.g., flue gas) with a PEP variant or composition thereof, and optionally releasing the captured CO₂, are also described herein.

Accordingly, a first aspect of the present disclosure includes an absorbent compound for capturing carbon dioxide (CO₂) having a chemical structure represented by Formula I:

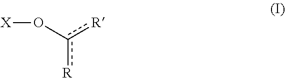

wherein [symbol] is a double or single bond;
   X is a phosphono, —[PO₃H]⁻ or —[PO₃]²⁻ group, a sulfo or —[SO₃]⁻ group, or a nitro group; and
   R and R′ are independently selected from the group consisting of hydrogen, a halogen, a hydroxyl group, an oxo group, an optionally substituted alkyl group, an optionally substituted cycloalkyl group, an optionally substituted alkenyl group, an optionally substituted aryl group, a heterocyclic group, an acyl group, a carboxyl group, a carboxylate group, alkoxy group, an aryloxy group, an alkylsulfonyl group, an arylsulfonyl group, and combinations thereof, or a salt thereof,
with the proviso that at least one of R and R′ has an ion or is ionizable and the compound is not phosphoenolpyruvic acid, phosphoenolpyruvate, sulfoenolpyruvic acid, or sulfoenolpyruvate, or a salt thereof.

In one or more embodiments of the first aspect, R is CH₂ and R′ includes an alkene, an alkyne, or an aryl group, or R is a methyl group and R′ is a carboxylate group. X can be a phosphono or sulfo group, or a conjugated base thereof. R′ can be a carboxyl group or a carboxylate group and R is a hydrogen, a hydroxyl group, an oxo group, a carboxyl group or a carboxylate group, optionally the compound is phosphoenol-buten(3,4)one, phosphoenol-3-methylene-but-1-ynone, phosphoenol-keto-ethenyl-benzene, or phosphoenol-2-oxo-hex(4,5)enoate. R can be (CHₐY_{b})_{d}, where a is 2, 1 or 0, b is 1 or 0, and b+a<2, Y is selected from OH, CHOH, C(═O)OH, O, CH₂, CHCH₃; and d is from 1 to 6; optionally the compound is 2-hydroxy-2(phosphonooxy)acetic acid, 2-(phosphonooxy)acetic acid, 2-(phosphonooxy)malonic acid, 2-oxo-2-(phosphonooxy)acetic acid or (E)-3-hydroxy-2-(phosphonooxy)acrylic acid.

A second aspect of the present disclosure features a CO₂ capture composition comprising the absorbent compound of any one of the embodiments of the first aspect, or any combination of embodiments of the first aspect and a carrier, vehicle, diluent or solid support. The composition can include about 0.1% to 90% or about 0.5% to 60% the absorbent compound of Formula I, by weight. The composition can include at least 25% the absorbent compound, by weight, such as about 30% to about 60% by weight, about 35% to about 55% by weight, or about 40% to about 50% by weight. The liquid carrier, vehicle or diluent can be selected from the group consisting of water, saline, buffered solutions, hydroalcoholic mixtures, and alcohols.

In a third aspect, the present disclosure features a method of capturing carbon dioxide (CO₂) from a gas stream containing CO₂, the method comprising: contacting a CO₂-containing gas stream with an absorbent, the absorbent reversibly reacting with CO₂ in a reaction to capture CO₂ from the gas stream, wherein the absorbent has a chemical structure represented by Formula I:

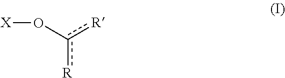

wherein [symbol] is a double or single bond;
   X is a phosphono, —[PO₃H]⁻ or —[PO₃]²⁻ group, a sulfo or —[SO₃]⁻), or a nitro group; and
   R and R′ are independently selected from the group consisting of hydrogen, a halogen, a hydroxyl group, an oxo group, an optionally substituted alkyl group, an optionally substituted cycloalkyl group, an optionally substituted alkenyl group, an optionally substituted aryl group, a heterocyclic group, an acyl group, a carboxyl group, a carboxylate group, alkoxy group, an aryloxy group, an alkylsulfonyl group, an arylsulfonyl group, and combinations thereof, or a salt thereof,
with the proviso that at least one of R and R′ has an ion or is ionizable and the compound is not phosphenolpyruvic acid, phosphoenolpyruvate, sulfoenolpyruvic acid or sulfoenolpyruvate, or a salt thereof.

The method of the third aspect can further include releasing the captured CO₂ from the absorbent via a stripping process. Releasing the captured CO₂ can be performed by reversing the reaction of the absorbent and CO₂. Releasing the captured CO₂ can be performed in the absence of enzymes. The stripping process can be performed by a stripper and operating the stripper can includes at least one of: increasing an operating temperature inside the stripper, decreasing the operating temperature inside the stripper, increasing an operating pressure inside the stripper, and decreasing the operating pressure inside the stripper. The method can further include increasing a temperature of the CO₂-containing absorbent, after the capturing step and prior to the releasing step, using heat from the absorbent after the absorbent exits the stripper.

In a fourth aspect, the present disclosure features a device for capturing carbon dioxide (CO₂) from a gas stream containing CO₂, the device comprising: an absorbent; and an absorber comprising:
a gas inlet to receive a gas stream for circulation through the absorber, the gas stream containing CO₂; an absorbent inlet to receive the absorbent for circulation through the absorber, the absorbent selectively and reversibly reacting with CO₂ inside the absorber to capture the CO₂ and form a CO₂-containing absorbent;
a gas outlet for exit of the gas stream from the absorber; and
an absorbent outlet for exit of the CO₂-containing absorbent from the absorber;
wherein the absorbent has a chemical structure represented by Formula I:

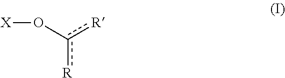

wherein [symbol] is a double or single bond;
X is a phosphono, —[PO₃H]⁻ or —[PO₃]²⁻ group, a sulfo or —[SO₃]⁻), or a nitro group; and
   R and R′ are independently selected from the group consisting of hydrogen, a halogen, a hydroxyl group, an oxo group, an optionally substituted alkyl group, an optionally substituted cycloalkyl group, an optionally substituted alkenyl group, an optionally substituted aryl group, a heterocyclic group, an acyl group, a carboxyl group, a carboxylate group, alkoxy group, an aryloxy group, an alkylsulfonyl group, an arylsulfonyl group, and combinations thereof, or a salt thereof,
with the proviso that at least one of R and R′ has an ion or is ionizable and the compound is not phosphoenolpyruvic acid, phosphoenolpyruvate, sulfoenolpyruvic acid or sulfoenolpyruvate, or a salt thereof.

In some embodiments of the fourth aspect, R is CH₂ and R′ is an alkene, an alkyne, or a aryl group, or R is a methyl group and R′ is a carboxylate group. X can be a phosphono or sulfo group, or a conjugated base thereof, R′ can be a carboxyl group or a carboxylate group and R can be a hydrogen, a hydroxyl group, an oxo group, a carboxyl group or a carboxylate group. In some cases, the absorbent includes phosphoenol-buten(3,4)one, phosphoenol-3-methylene-but-1-ynone, phosphoenol-keto-ethenyl-benzene, or phosphoenol-2-oxo-hex(4,5)enoate. R can be (CHₐY_{b})_{d}, where a is 2, 1 or 0, b is 1 or 0, and b+a<2, Y is selected from OH, CHOH C(═O)OH, O, CH₂, CHCH₃; and d is from 1 to 6, with the proviso that if R is CH₂, R′ is not carboxylate. The absorbent can include 2-hydroxy-2(phosphonooxy)acetic acid, 2-(phosphonooxy)acetic acid, 2-(phosphonooxy)malonic acid, 2-oxo-2-(phosphonooxy)acetic acid or (E)-3-hydroxy-2-(phosphonooxy)acrylic acid. The absorbent composition can include a carrier, vehicle, or diluent selected from the group consisting of water, saline, buffered solutions, hydroalcoholic mixtures, and alcohols.

In a fifth aspect, the present disclosure features a system comprising the device of any embodiment or combination of embodiments of the fourth aspect, and a stripper configured to receive steam and the CO₂-containing absorbent to reverse the reaction between CO₂ and the absorbent thereby releasing CO₂ from the absorbent, wherein the absorbent can be recirculated back to the absorber for re-use. The system can further include a heat exchanger configured to circulate the absorbent exiting the stripper and the CO₂-containing absorbent exiting the absorber, wherein the absorbent exiting the stripper rejects heat to the CO₂-containing absorbent. In some cases, operation of the stripper includes at least one of: increasing an operating temperature inside the stripper, decreasing the operating temperature inside the stripper, increasing an operating pressure inside the stripper, and decreasing the operating pressure inside the stripper.

The details of one or more examples are set forth in the description below. Other features, objects, and advantages will be apparent from the description and from the claims.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views.

Reference is made to illustrative embodiments that are depicted in the figures, in which:

FIG. 1 shows an exemplary reaction mechanism for carbon capture by phosphoenol compounds, according to one or more embodiments of the present disclosure.

FIG. 2 is a schematic representation of a carbon capture system, according to one or more embodiments of the present disclosure.

FIG. 3 shows phosphoenolpyruvate (PEP) reaction enthalpy, according to one or more embodiments of the present disclosure.

FIGS. 4A and 4B shows the phosphoenol reaction enthalpies for ketoalkenes (FIG. 4A) and ketoalkynes (FIG. 4B), according to one or more embodiments of the present disclosure.

FIGS. 5A and 5B shows the phosphoenol reaction enthalpies for ketoaryls (FIG. 5A) and ketoacids (FIG. 5B), according to one or more embodiments of the present disclosure.

FIG. 6 is a plot of total energy to show the potential energy difference between mixed and unmixed solutions, according to one or more embodiments of the present disclosure.

FIGS. 7A and 7B are plots of radial distribution functions of carbon (FIG. 7A) and phosphorous (FIG. 7B) atoms in a PEP solution, according to one or more embodiments of the present disclosure.

FIG. 8 is a plot of viscosity as a function of concentration of aqueous PEP (% weight), according to one or more embodiments of the present disclosure.

FIG. 9 is a plot of diffusion coefficient as a function of concentration of aqueous PEP (% weight), according to one or more embodiments of the present disclosure.

FIG. 10 shows PEP (C₃H₅O₆P) and the free energy diagram thereof.

FIG. 11 shows an exemplary PEP variant (C₂H₅O₆P) and the free energy diagram thereof, according to one or more embodiments of the present disclosure.

FIG. 12 shows an exemplary PEP variant (C₂H₅O₇P) and the free energy diagram thereof, according to one or more embodiments of the present disclosure.

FIG. 13 shows an exemplary PEP variant (C₃H₅O₈P) and the free energy diagram thereof, according to one or more embodiments of the present disclosure.

FIG. 14 shows an exemplary PEP variant (C₂H₃O₇P) and the free energy diagram thereof, according to one or more embodiments of the present disclosure.

FIG. 15 shows an exemplary PEP variant (C₃H₅O₇P) and the free energy diagram thereof, according to one or more embodiments of the present disclosure.

FIG. 16 shows bond order and non-bond order dependent energies in reactive MD simulation, according to one or more embodiments of the present disclosure.

FIG. 17 is a flowchart illustrating workflow of an overall optimization process for ReaxFF parameterization, according to one or more embodiments of the present disclosure.

FIGS. 18A-18F are plots illustrating bond dissociation energy comparisons between DFT and ReaxFF, according to one or more embodiments of the present disclosure.

FIGS. 19A and 19B show bond length and bond dissociation energy for PEP and PEP variants, according to one or more embodiments of the present disclosure.

FIG. 20 shows decomposition barriers for triply charged PEP and PEP variants, according to one or more embodiments of the present disclosure.

FIG. 21 is a schematic representation of a carbon capture system, according to one or more embodiments of the present disclosure, according to one or more embodiments of the present disclosure.

FIGS. 22A and 22B are schematic representations of an exemplary molecule in a transition state and neutralized system, respectively, according to one or more embodiments of the present disclosure.

FIGS. 22C-22H are schematic representations of neutralized systems of other charged molecules, according to one or more embodiments of the present disclosure.

FIGS. 23A and 23B are plots of average partial charge and bond length, respectively, compared to QM, according to one or more embodiments of the present disclosure.

FIG. 23C is a schematic representation of the neutral forms of molecules, according to one or more embodiments of the present disclosure.

FIG. 23D is a plot of average angle, compared to QM, according to one or more embodiments of the present disclosure.

FIGS. 24A-24D are plots of bond dissociation energy scans, comparing ReaxFF to QM, according to one or more embodiments of the present disclosure.

FIGS. 25A and 25B are plots of calculated diffusion coefficients and radial distribution functions (RDFs) compared to literature values, according to one or more embodiments of the present disclosure.

FIG. 26 is a schematic representation of the reaction sequence for PEP in water with bicarbonate, according to one or more embodiments of the present disclosure.

FIGS. 27A-27C are plots of partial charge and oxygen number for reacting PEPs, according to one or more embodiments of the present disclosure.

FIG. 27D is a plot of partial charge and oxygen number for non-reacting PEP, for comparison, according to one or more embodiments of the present disclosure.

### DETAILED DESCRIPTION

Embodiments of the present disclosure describe PEP variants possessing CO₂ capture activity, for use as carbon capture solvents and devices/systems configured to capture, and optionally to release, CO₂ and methods of capturing CO₂.

### Definitions

The terms recited below have been defined as described below. All other terms and phrases in this disclosure shall be construed according to their ordinary meaning as understood by one of skill in the art.

As used herein, “about” or “approximately,” when used in connection with a numerical variable, generally refers to the value of the variable and to all values of the variable that are within the experimental error (e.g., within the 95% confidence interval for the mean) or within ±10% of the indicated value, whichever is greater.

As used herein, “heating” refers to increasing a temperature. For example, heating may refer to exposing or subjecting any environment, apparatus, object, material, etc. to a temperature that is greater than a current or previous temperature. In some cases, the current or previous temperature is the temperature of one or more of the environment, apparatus, object, material, etc.

The term “PEP variant” refers to an absorbent compound for non-enzymatic carbon capture based on phosphoenolpyruvate, encompassed by Formula I below, and is used interchangeably with “absorbent” in the present disclosure.

When used in the context of a chemical group, “hydrogen” means —H; “hydroxy” means —OH; “oxo” means ═O; “halo” means independently —F, —Cl, —Br or —I; “nitro” means —NO₂; “cyano” means —CN; “isocyanate” means —N═C═O; “azido” means —N₃; in a monovalent context “phosphate” means —OP(O)(OH)₂ or a deprotonated form thereof; in a divalent context “phosphate” means —OP(O)(OH)O— or a deprotonated form thereof; “mercapto” means —SH; “thio” means ═S; “thioether” means ═S—; “sulfonyl” means —S(O)₂— (see below for definitions of groups containing the term sulfonyl, e.g., alkylsulfonyl); and “sulfinyl” means —S(O)— (see below for definitions of groups containing the term sulfinyl, e.g., alkylsulfinyl).

In the context of chemical formulas, the symbol “-” means a single bond, means a double bond. The symbol “ [symbol] ” represents a single bond or a double bond.

For the groups and classes below, the following parenthetical subscripts further define the group/class as follows: “(Cn)” defines the exact number (n) of carbon atoms in the group/class. “(C≤n)” defines the maximum number (n) of carbon atoms that can be in the group/class, with the minimum number as small as possible for the group in question, e.g., it is understood that the minimum number of carbon atoms in the group “alkenyl_{(c≤8)}” or the class “alkene_{(c≤8)}” is two. For example, “alkoxy_{(c≤10)}” designates those alkoxy groups having from 1 to 10 carbon atoms (e.g., 1, 2, 3, 4, 5, 6, 7, 8, 9, or 10, or any range derivable therein (e.g., 3 to 10 carbon atoms). (Cn-n′) defines both the minimum (n) and maximum number (n′) of carbon atoms in the group. Similarly, “alkyl_{(C2-C10)}” designates those alkyl groups having from 2 to 10 carbon atoms (e.g., 2, 3, 4, 5, 6, 7, 8, 9, or 10, or any range derivable therein (e.g., 3 to 10 carbon atoms)).

As used herein, “substituted” refers to all permissible substituents of the compounds described herein. In the broadest sense, the permissible substituents include acyclic and cyclic, branched and unbranched, carbocyclic and heterocyclic, aromatic and nonaromatic substituents of organic compounds. Non-limiting examples of substituents include halogens, hydroxyl groups, or any other organic groupings containing any number of carbon atoms, preferably 1-14 carbon atoms, and optionally include one or more heteroatoms such as oxygen, sulfur, or nitrogen grouping in linear, branched, or cyclic structural formats. Representative substituents include alkyl, substituted alkyl, alkenyl, substituted alkenyl, alkynyl, substituted alkynyl, phenyl, substituted phenyl, aryl, substituted aryl, heteroaryl, substituted heteroaryl, halo, hydroxyl, alkoxy, substituted alkoxy, phenoxy, substituted phenoxy, aroxy, substituted aroxy, alkylthio, substituted alkylthio, phenylthio, substituted phenylthio, arylthio, substituted arylthio, cyano, isocyano, substituted isocyano, carbonyl, substituted carbonyl, carboxyl, substituted carboxyl, sulfonyl, substituted sulfonyl, sulfonic acid, phosphoryl, substituted phosphoryl, phosphonyl, substituted phosphonyl, polyaryl, substituted polyaryl, C₃-C₂₀ cyclic, substituted C₃-C₂₀ cyclic, heterocyclic, and substituted heterocyclic. As discussed herein, heteroatoms such as nitrogen may have hydrogen substituents and/or any permissible substituents of organic compounds described herein which satisfy the valences of the heteroatoms. It is understood that “substitution” or “substituted” includes the implicit proviso that such substitution is in accordance with permitted valence of the substituted atom and the substituent, and that the substitution results in a stable compound, i.e., a compound that does not spontaneously undergo transformation such as by rearrangement, cyclization, elimination, etc.

As used herein, “heteroatom” means an atom of any element other than carbon or hydrogen. Preferred heteroatoms are boron, nitrogen, oxygen, phosphorus, sulfur, and selenium. Other heteroatoms include silicon and arsenic.

As used herein, the term “halide” designates —F, —Cl, —Br, or —I.

The term “aliphatic” when used without the “substituted” modifier signifies that the compound/group so modified is an acyclic or cyclic, but non-aromatic hydrocarbon compound or group. In aliphatic compounds/groups, the carbon atoms can be joined together in straight chains, branched chains, or non-aromatic rings (alicyclic). Aliphatic compounds/groups can be saturated, that is joined by single bonds (alkanes/alkyl), or unsaturated, with one or more double bonds (alkenes/alkenyl) or with one or more triple bonds (alkynes/alkynyl). When the term “aliphatic” is used without the “substituted” modifier only carbon and hydrogen atoms are present. When the term is used with the “substituted” modifier one or more hydrogen atom has been independently replaced by —OH, —F, —Cl, —Br, —I, —NO₂, —CO₂H, —CO₂CH₃, —CN, —SH, —OCH₃, —OCH₂CH₃, —C(O)CH₃, or —OC(O)CH₃.

As used herein, “alkyl” refers to the radical of saturated aliphatic groups (i.e., an alkane with one hydrogen atom removed), including straight-chain alkyl groups, branched chain alkyl groups, cycloalkyl (alicyclic) groups, alkyl-substituted cycloalkyl groups, and cycloalkyl-substituted alkyl groups. A straight chain or branched chain alkyl has 30 or fewer carbon atoms in its backbone (e.g., C₁-C₃₀ for straight chains, and C₃-C₃₀ for branched chains), preferably 20 or fewer, more preferably 15 or fewer, most preferably 10 or fewer. Likewise, preferred cycloalkyls have 3-10 carbon atoms in their ring structure, and more preferably have 5, 6, or 7 carbons in the ring structure. The groups —CH₃ (Me), —CH₂CH₃ (Et), —CH₂CH₂CH₃ (n-Pr), —CH(CH₃)₂(iso-Pr), —CH(CH₂)₂(cyclopropyl), —CH₂CH₂CH₂CH₃ (n-Bu), —CH(CH₃)CH₂CH₃ (sec-butyl), —CH₂CH(CH₃)₂(iso-butyl), —C(CH₃)₃(tert-butyl), —CH₂C(CH₃)₃(neo-pentyl), cyclobutyl, cyclopentyl, cyclohexyl, and cyclohexylmethyl are non-limiting examples of alkyl groups.

The term “alkyl” is intended to include both “unsubstituted alkyls” and “substituted alkyls” having one or more substituents replacing a hydrogen on one or more carbons of the hydrocarbon backbone. Exemplary substituents include, without limitation, halogen, hydroxyl, carbonyl (such as a carboxyl, alkoxycarbonyl, formyl, or an acyl), thiocarbonyl (such as a thioester, a thioacetate, or a thioformate), alkoxyl, phosphoryl, phosphate, phosphonate, phosphinate, cyano, nitro, azido, sulfhydryl, alkylthio, sulfate, sulfonate, sulfamoyl, sulfonamide, sulfonyl, heterocyclyl, aralkyl or an aromatic or heteroaromatic moiety.

As used herein “heteroalkyl” refers to straight or branched chain, or cyclic carbon containing radicals, or combinations thereof, containing at least one heteroatom. Suitable heteroatoms include, but are not limited to, O, N, Si, P, Se, B, and S, wherein the phosphorous and sulfur atoms are optionally oxidized, and the nitrogen heteroatom is optionally quaternized. Heteroalkyls can be substituted as defined above for alkyl groups.

The term “alkanediyl” when used without the “substituted” modifier refers to a divalent saturated aliphatic group, with one or two saturated carbon atom(s) as the point(s) of attachment, a linear or branched, cyclo, cyclic or acyclic structure, no carbon-carbon double or triple bonds, and no atoms other than carbon and hydrogen. The groups, —CH₂— (methylene), —CH₂CH₂—, —CH₂C(CH₃)₂CH₂—, and CH₂CH₂CH₂— are non-limiting examples of alkanediyl groups.

The term “alkylidene” when used without the “substituted” modifier refers to the divalent group —CRR′ in which R and R′ are independently hydrogen, alkyl, or R and R′ are taken together to represent an alkanediyl having at least two carbon atoms. Non-limiting examples of alkylidene groups include: ═CH₂, ═CH(CH₂CH₃), and ═C(CH₃)₂. When any of these terms is used with the “substituted” modifier one or more hydrogen atom has been independently replaced by —OH, —F, —Cl, —Br, —I, —NO₂, —CO₂H, —CO₂CH₃, —CN, —SH, —OCH₃, —OCH₂CH₃, —C(O)CH₃, or −OC(O)CH₃. The following groups are non-limiting examples of substituted alkyl groups: —CH₂OH, —CH₂Cl, —CF₃, —CH₂CN, —CH₂C(O)OH, —CH₂C(O)OCH₃, —CH₂C(O)CH₃, —CH₂OCH₃, —CH₂OC(O)CH₃, and —CH₂CH₂Cl. The term “fluoroalkyl” is a subset of substituted alkyl, in which one or more hydrogen has been substituted with a fluoro group and no other atoms aside from carbon, hydrogen and fluorine are present. The groups, —CH₂F, —CF₃, and —CH₂CF₃ are non-limiting examples of fluoroalkyl groups. An “alkane” refers to the compound H—R, wherein R is alkyl.

The term “alkenyl” when used without the “substituted” modifier refers to a monovalent unsaturated aliphatic group with a carbon atom as the point of attachment, a linear or branched, cyclo, cyclic or acyclic structure, at least one nonaromatic carbon-carbon double bond, no carbon-carbon triple bonds, and no atoms other than carbon and hydrogen. Non-limiting examples of alkenyl groups include: —CH═CH₂ (vinyl), —CH═CHCH₃, —CH═CHCH₂CH₃, —CH₂CH═CH₂ (allyl), —CH₂CH═CHCH₃, and —CH═CH—C₆H₅. The term “alkenediyl” when used without the “substituted” modifier refers to a divalent unsaturated aliphatic group, with two carbon atoms as points of attachment, a linear or branched, cyclo, cyclic or acyclic structure, at least one nonaromatic carbon-carbon double bond, no carbon-carbon triple bonds, and no atoms other than carbon and hydrogen (e.g., —CH═CH—, —CH═C(CH₃)CH₂—, and —CH═CHCH₂—) are non-limiting examples of alkenediyl groups. When these terms are used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, or —OC(O)CH₃. The groups, —CH═CHF, —CH═CHCl and —CH═CHBr, are non-limiting examples of substituted alkenyl groups. An “alkene” refers to the compound H—R, wherein R is alkenyl.

The term “alkynyl” when used without the “substituted” modifier refers to a monovalent unsaturated aliphatic group with a carbon atom as the point of attachment, a linear or branched, cyclo, cyclic or acyclic structure, at least one carbon-carbon triple bond, and no atoms other than carbon and hydrogen. As used herein, the term alkynyl does not preclude the presence of one or more non-aromatic carbon-carbon double bonds. The groups, —C≡CH, —C≡CCH₃, and —CH₂C≡CCH₃, are non-limiting examples of alkynyl groups. The term “alkynediyl” when used without the “substituted” modifier refers to a divalent unsaturated aliphatic group, with two carbon atoms as points of attachment, a linear or branched, cyclo, cyclic or acyclic structure, at least one carbon-carbon triple bond, and no atoms other than carbon and hydrogen. When these terms are used with the “substituted” modifier one or more hydrogen atom has been independently replaced by —OH, —F, —Cl, —Br, —I, —NO₂, —CO₂H, —CO₂CH₃, —CN, —SH, —OCH₃, —OCH₂CH₃, —C(O)CH₃, or —OC(O)CH₃. An “alkyne” refers to the compound H—R, wherein R is alkynyl.

The term “aryl” when used without the “substituted” modifier refers to a monovalent unsaturated aromatic group with an aromatic carbon atom as the point of attachment, said carbon atom forming part of a one or more six-membered aromatic ring structure, wherein the ring atoms are all carbon, and wherein the group consists of no atoms other than carbon and hydrogen. If more than one ring is present, the rings may be fused or not fused. As used herein, the term does not preclude the presence of one or more alkyl group (carbon number limitation permitting) attached to the first aromatic ring or any additional aromatic ring present. Non-limiting examples of aryl groups include phenyl (Ph), methylphenyl, (dimethyl)phenyl, —C₆H₄—CH₂CH₃ (ethylphenyl), naphthyl, and the monovalent group derived from biphenyl. The term “arenediyl” when used without the “substituted” modifier refers to a divalent aromatic group, with two aromatic carbon atoms as points of attachment, said carbon atoms forming part of one or more six-membered aromatic ring structure(s) wherein the ring atoms are all carbon, and wherein the monovalent group consists of no atoms other than carbon and hydrogen. As used herein, the term does not preclude the presence of one or more alkyl group (carbon number limitation permitting) attached to the first aromatic ring or any additional aromatic ring present. If more than one ring is present, the rings may be fused or unfused. When these terms are used with the “substituted” modifier one or more hydrogen atom has been independently replaced by —OH, —F, —Cl, —Br, —I, —NO₂, —CO₂H, —CO₂CH₃, —CN, —SH, —OCH₃, —OCH₂CH₃, —C(O)CH₃, or —OC(O)CH₃. An “arene” refers to the compound H—R, wherein R is aryl.

The term “aralkyl” when used without the “substituted” modifier refers to the monovalent group-alkanediyl-aryl, in which the terms alkanediyl and aryl are each used in a manner consistent with the definitions provided above. Non-limiting examples of aralkyls are: phenylmethyl (benzyl, Bn) and 2-phenyl-ethyl. When the term is used with the “substituted” modifier one or more hydrogen atom from the alkanediyl and/or the aryl has been independently replaced by —OH, —F, —Cl, —Br, —I, —NO₂, —CO₂H, —CO₂CH₃, —CN, —SH, —OCH₃, —OCH₂CH₃, —C(O)CH₃, or —OC(O)CH₃. Non-limiting examples of substituted aralkyls are: (3-chlorophenyl)-methyl and 2-chloro-2-phenyl-eth-1-yl.

The term “heteroaryl” when used without the “substituted” modifier refers to a monovalent aromatic group with an aromatic carbon atom or nitrogen atom as the point of attachment, said carbon atom or nitrogen atom forming part of an aromatic ring structure wherein at least one of the ring atoms is nitrogen, oxygen or sulfur, and wherein the group consists of no atoms other than carbon, hydrogen, aromatic nitrogen, aromatic oxygen and aromatic sulfur. As used herein, the term does not preclude the presence of one or more alkyl group (carbon number limitation permitting) attached to the aromatic ring or any additional aromatic ring present. Non-limiting examples of heteroaryl groups include furanyl, imidazolyl, indolyl, indazolyl, methylpyridyl, oxazolyl, pyridyl, pyrrolyl, pyrimidyl, pyrazinyl, quinolyl, quinazolyl, quinoxalinyl, thienyl, and triazinyl. The term “heteroarenediyl” when used without the “substituted” modifier refers to an divalent aromatic group, with two aromatic carbon atoms, two aromatic nitrogen atoms, or one aromatic carbon atom and one aromatic nitrogen atom as the two points of attachment, said atoms forming part of one or more aromatic ring structure(s) wherein at least one of the ring atoms is nitrogen, oxygen or sulfur, and wherein the divalent group consists of no atoms other than carbon, hydrogen, aromatic nitrogen, aromatic oxygen and aromatic sulfur. As used herein, the term does not preclude the presence of one or more alkyl group (carbon number limitation permitting) attached to the first aromatic ring or any additional aromatic ring present. If more than one ring is present, the rings may be fused or unfused. When these terms are used with the “substituted” modifier one or more hydrogen atom has been independently replaced by —OH, —F, —Cl, —Br, —I, —NO₂, —CO₂H, —CO₂CH₃, —CN, —SH, —OCH₃, —OCH₂CH₃, —C(O)CH₃, or —OC(O)CH₃.

The term “acyl” when used without the “substituted” modifier refers to the group —C(O)R, in which R is a hydrogen, alkyl, aryl, aralkyl or heteroaryl, as those terms are defined above. The groups, —CHO, —C(O)CH₃ (acetyl, Ac), —C(O)CH₂CH₃, —C(O)CH₂CH₂CH₃, —C(O)CH(CH₃)₂, —C(O)CH(CH₂)₂, —C(O)C₆H₅, —C(O)C₆H₄—CH₃, —C(O)CH₂C₆H₅, —C(O)(imidazolyl) are non-limiting examples of acyl groups. A “thioacyl” is defined in an analogous manner, except that the oxygen atom of the group —C(O)R has been replaced with a sulfur atom, —C(S)R. When either of these terms are used with the “substituted” modifier one or more hydrogen atom has been independently replaced by —OH, —F, —Cl, —Br, —I, —NO₂, —CO₂H, —CO₂CH₃, —CN, —SH, —OCH₃, —OCH₂CH₃, —C(O)CH₃, or —OC(O)CH₃. The groups, —C(O)CH₂CF₃, —CO₂H (carboxyl), —CO₂CH₃ (methylcarboxyl), and —CO₂CH₂CH₃ are non-limiting examples of substituted acyl groups.

The term “alkoxy” when used without the “substituted” modifier refers to the group —OR, in which R is an alkyl, as that term is defined above. Non-limiting examples of alkoxy groups include: —OCH₃, —OCH₂CH₃, —OCH₂CH₂CH₃, —OCH(CH₃)₂, —OCH(CH₂)₂, —O-cyclopentyl, and —O-cyclohexyl. The terms “alkenyloxy”, “alkynyloxy”, “aryloxy”, “aralkoxy”, “heteroaryloxy”, and “acyloxy”, when used without the “substituted” modifier, refers to groups, defined as —OR, in which R is alkenyl, alkynyl, aryl, aralkyl, heteroaryl, and acyl, respectively. Similarly, the term “alkylthio” when used without the “substituted” modifier refers to the group —SR, in which R is an alkyl, as that term is defined above. When any of these terms are used with the “substituted” modifier one or more hydrogen atom has been independently replaced by —OH, —F, —Cl, —Br, —I, —NO₂, —CO₂H, —CO₂CH₃, —CN, —SH, —OCH₃, —OCH₂CH₃, —C(O)CH₃, or —OC(O)CH₃. The term “alcohol” corresponds to an alkane, as defined above, wherein at least one of the hydrogen atoms has been replaced with a hydroxy group.

The term “reversible” or variants thereof (e.g., “reversibly”) with respect to a chemical reaction means that one or more steps of the reaction can proceed in either direction (backward or forward) depending on the reaction conditions.

### A. CO₂ Capture Compounds: PEP Variants

Embodiments of the present disclosure describe absorbent compounds for capturing carbon dioxide (CO₂) based on phosphoenolpyruvate (PEP) having chemical structure represented by Formula I:

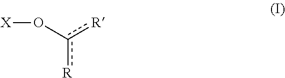

wherein [symbol] is a double or single bond (a double bond in one of the indicated positions and a single bond in the other, or a single bond in both positions);
X is an anionic moiety selected from a phosphono (—PO₃H₂) group or its conjugated bases (—[PO₃H]⁻ and —[PO₃]²⁻), a sulfo (—SO₃H) group or its conjugated base (i.e., [SO₃]⁻), or a nitro group; and
R and R′ are independently selected from the group consisting of hydrogen, a halogen, a hydroxyl group, an oxo group, an optionally substituted alkyl group, an optionally substituted cycloalkyl group, an optionally substituted alkenyl group, an optionally substituted aryl group, a heterocyclic group, an acyl group, a carboxyl group, a carboxylate group, alkoxy group, an aryloxy group, an alkylsulfonyl group, an arylsulfonyl group, and combinations thereof, or a salt thereof, with the proviso that at least one of R and R′ has an ion or is ionizable and the absorbent compound is not phosphoenolpyruvate or sulfoenolpyruvate.

The compounds of Formula I (also referred to as PEP variants herein) can be capable of forming acid and/or base salts by virtue of the presence of amino and/or carboxyl groups or groups similar thereto. Acceptable base addition salts can be prepared from inorganic and organic bases. Salts derived from inorganic bases, include by way of example only, sodium, potassium, lithium, ammonium, calcium and magnesium salts.

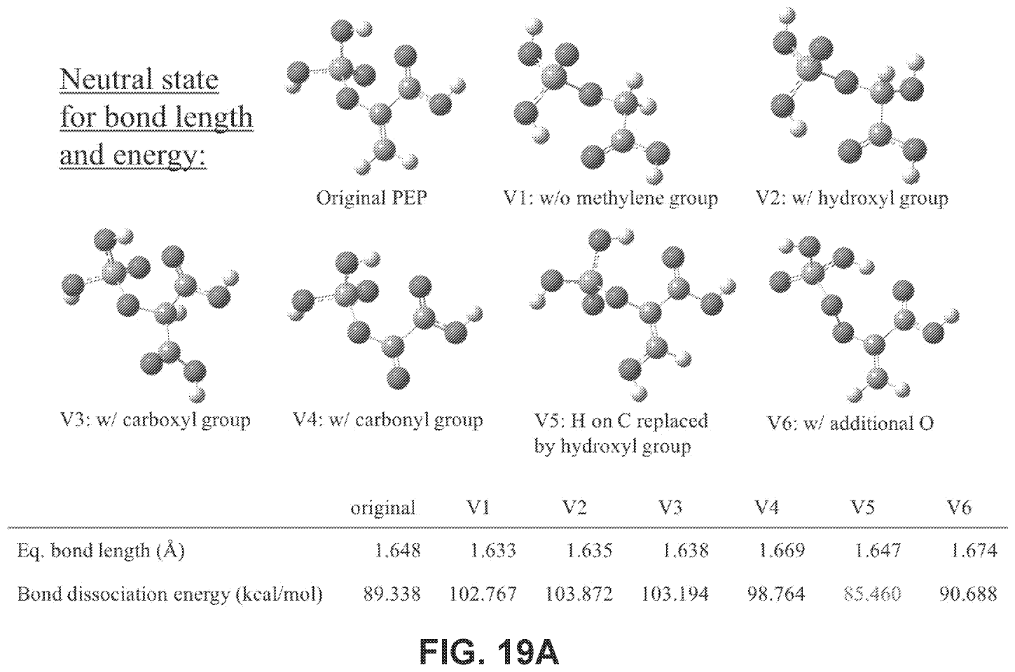

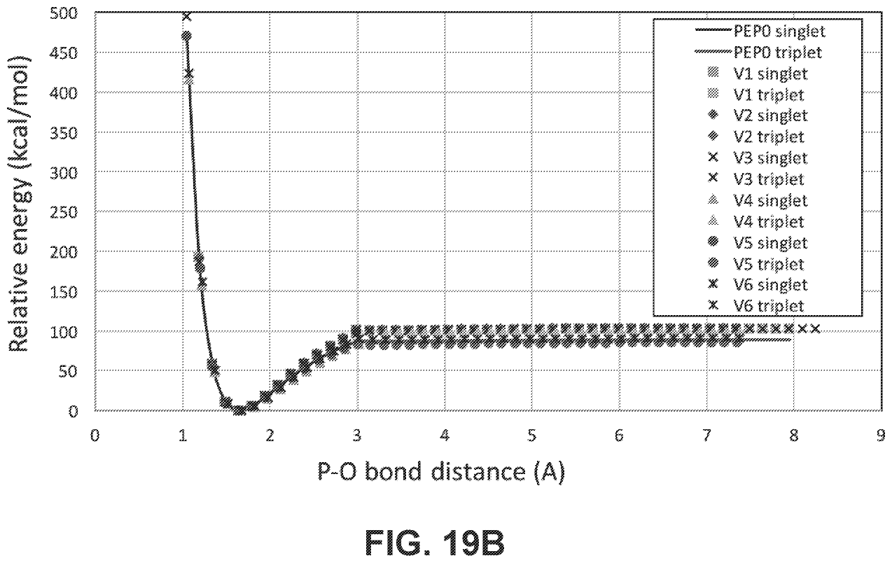

Exemplary PEP variants according to Formula I include embodiments wherein R is CH₂ and R′ includes an alkene, an alkyne, or an aryl group, or R is a methyl group and R′ is a carboxylate group (e.g., a saturated or unsaturated fatty acid). In some cases, X is a —[PO₃H]⁻ or —[PO₃]²⁻ group, or sulfonato (—[SO₃]⁻) group, R′ is a carboxyl group or a carboxylate group and R is a hydrogen, a hydroxyl group, an oxo group, a carboxyl group or a carboxylate group, or and salts thereof. In some cases, the compound of Formula I is a PEP variant as described in FIG. 19A, For example, a PEP variant of the present disclosure can be phosphoenol-buten(3,4)one, phosphoenol-3-methylene-but-1-ynone, phosphoenol-keto-ethenyl-benzene, or phosphoenol-2-oxo-hex(4,5)enoate.

In one or more embodiments, R is (CHₐY_{b})_{d}, where a is 2, 1 or 0, b is 1 or 0, and b+a<2, Y is selected from OH, CHOH C(═O)OH, O, CH₂, CHCH₃; and d is from 1 to 6, with the proviso that if R is CH₂, R′ is not carboxylate. For example, a PEP variant of Formula I can be:

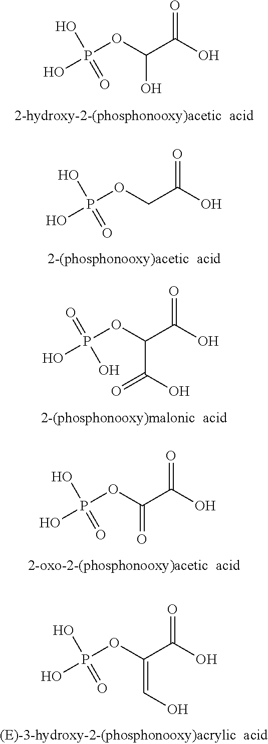 [SMILES: O=C(O)C(O)OP(=O)(O)O ; O=C(O)COP(=O)(O)O ; O=C(O)C(OP(=O)(O)O)C(=O)O ; O=C(O)C(=O)OP(=O)(O)O ; O=C(O)/C(=C\O)OP(=O)(O)O]

Methods for the chemical synthesis of exemplary PEP variants are described herein. These and other methods known to the skilled artisan can be modified and/or adapted to facilitate synthesis of additional compounds within the scope of Formula I.

A PEP variant of the present disclosure may be characterized by one or more of the following properties: a reaction enthalpy within an optimal range derived from process modeling of a Carbon Capture System (e.g., standard absorber/stripper architectures of a Post-Combustion Capture (PCC) system) and advantageous solution properties. In particular, the PEP variants advantageously exhibit a reduced tendency to cause corrosion, improved solubility, viscosity, and/or diffusivity, improved energetics and/or kinetics of reaction with the bicarbonate ion, improved reaction stoichiometry, or providing a net reduction in energy penalty relative to a particular benchmark (e.g., an amine-based absorbent). These properties can be evaluated using the methods known in the art or as described in the Examples.

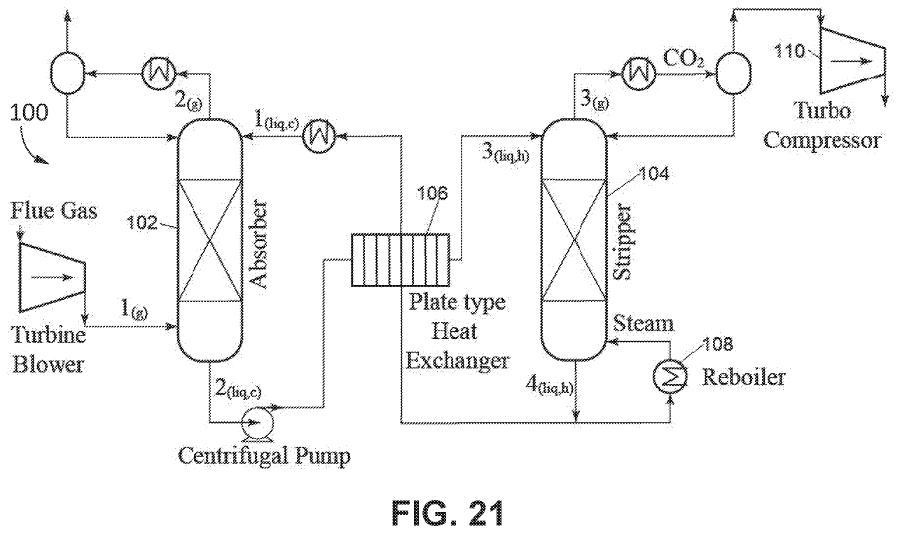

For example, the suitability of a PEP variant for non-enzymatic carbon capture can be evaluated by modeling. The Electric Power Research Institute (EPRI; Palo Alto, CA) maintains and operates Aspen Plus process models based on the absorber/stripper configuration shown in FIG. 21 and standard operational parameters (e.g., as described in the Examples). These models are configured to accept generalized solvent (absorbent) properties and calculate the resulting energy penalty. Model inputs can include the solubility, viscosity, and heat capacity of the PEP variant, as well as the CO₂ vapor liquid equilibrium (VLE) of the underlying carbon capture reaction equilibrium (absorption/desorption). VLE describes the number of moles CO₂ per unit volume solution absorbed via reaction and dissolution as a function of CO₂ partial pressure above solution. At low temperature (e.g., 40° C. absorber), products are favored, and gaseous CO₂ is drawn into aqueous solution via reaction of the bicarbonate ion HCO₃ with the solvent (absorption). At higher temperature (e.g., 120° C. stripper), reactants are favored and HCO₃ desorbs, releasing CO₂ back into the gas phase for capture and compression. The difference ACO₂ between these temperature extremes determines the absorption capacity of the solvent, or cyclic capacity of the absorber/stripper system.

These models can be used to quantify the energy penalty of a PEP variant for carbon capture chemistry relative to the MEA benchmark. For example, an absorber VLE curve for MEA (11% mole fraction) shows that the system is in thermodynamic equilibrium at CO₂ partial pressures significantly below that of supercritical pulverized coal power plant (SCPC) and combined cycle natural gas power plant (CCNG) flue gas concentrations (1.43 and 1.86 mol/kg for SCPC and CCNG, respectively). This equates to 71% and 84% cyclic efficiency (i.e., 71% and 84% of CO₂ reacting with MEA at absorber conditions for SCPC and CCNG, respectively, is desorbed and released for compression at stripper conditions). The remaining 29% and 16% remain bound in solution during repeated absorber-stripper cycling. Therefore, in some cases, a PEP variant of the present disclosure exhibits improved cyclic capacity and/or efficiency relative to MEA at one or more concentrations (e.g., % mole fractions). The improvement can be evaluated at the temperatures of the absorber (40° C.) and stripper (120° C.). For example, a PEP variant of the present disclosure can exhibit greater than 71% cyclic efficiency for SCPC, such as greater than about 75%, 80%, 85%, 90%, 95%, 96%, 97%, 98%, 99%, 99.5%, 99.9%, or about 100% cyclic efficiency for SCPC, greater than 84% cyclic efficiency for CCNG, such as greater than about 85%, 90%, 95%, 96%, 97%, 98%, 99%, 99.5%, 99.9%, or about 100% cyclic efficiency for CCNG.

A PEP variant of the present disclosure can also be characterized by improved reaction stoichiometry, relative to MEA. For example, a PEP variant of Formula I can be half that of MEA, i.e., each molecule of the PEP variant can absorb one CO₂ molecule while it takes two MEA molecules per CO₂.

### B. CO₂ Capture Compositions

Embodiments of the present disclosure describe compositions comprising the absorbent compounds of Formula I for CO₂ chemical absorption. The compositions facilitate selective reaction with CO₂ (or bicarbonate) and the PEP variant of Formula I. In one or more embodiments, the composition is capable of reversibly reacting with CO₂ (or bicarbonate). For example, a generalized reaction is based on a four-step process encompassing (1) dissolution of CO₂ into the aqueous phases via Henry's law, (2) hydrolysis and ionization of aqueous CO₂, (3) dissociation of the bicarbonate ion and (4) reaction with the absorbent compound.

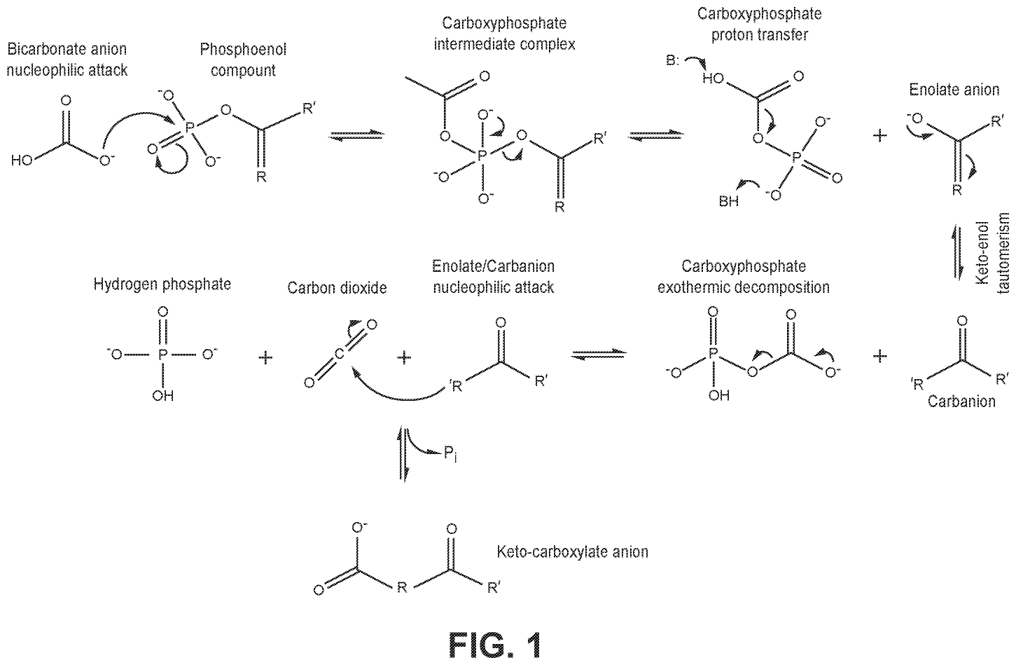

One non-limiting mechanism for CO₂ chemical absorption by a capture composition of the present disclosure is shown in FIG. 1, in which the PEP variant is a phosphoenol compound. In FIG. 1, a bicarbonate anion acts as a nucleophile to attack the anionic moiety of a PEP variant, which results in the PEP variant splitting into a carboxyphosphate and a reactive enolate anion. Unlike the carbon capture mechanism of CAM plants, the PEP variant may also be capable of reversible CO₂ capture in the capture composition, without the use of enzyme or other catalytic activity. In some cases, the PEP variant is capable of absorbing CO₂ in a single step. In some cases, after CO₂ absorbed, the absorbent is regenerable, i.e., capable of reacting with bicarbonate in a single step and reverting to the original structure when the composition is subjected to conditions that promote release of the bicarbonate. For example, the PEP variant of the capture composition may react by swapping the bicarbonate anion for the anionic moiety, in a single step, without changing the organic portion of the PEP variant.

The compositions of the present disclosure can be in the form of solutions, suspensions, dispersions, slurries, powders, or particles, or other forms suitable for use in an intended Carbon Capture System. In one or more embodiments, the CO₂ capture composition is a fluid composition (e.g., a solution, suspension, or slurry) comprising at least one PEP variant of Formula I and a liquid vehicle, carrier or diluent. Liquid vehicles/carriers/diluents of the present disclosure include, but are not limited to, water, saline, buffered solutions, hydroalcoholic mixtures, and alcohols. The alcohol can be selected from ethanol, methanol, isopropyl alcohol, and combinations thereof. In some cases, the fluid composition includes a co-solvent system with both a protic and aprotic solvent (e.g., an organic solvent) to improve the pumpability of the CO₂ capture composition. Protic solvents can be selected from water, formic acid (HCO₂H), n-butanol (CH₃CH₂CH₂CH₂OH), isopropanol ((CH₃)₂CH(OH)), nitromethane (CH₃NO₂), ethanol (CH₃CH₂OH), methanol (CH₃OH), and acetic acid (CH₃CO₂H), or the like.

The concentration of PEP variant in the fluid composition can vary based on its intended application. Generally, the CO₂ capture composition will contain about 0.1% to 90% or about 0.5% to 60%, by weight of a PEP variant of Formula I, the remainder being carrier, vehicle, and/or diluent. In some cases, the CO₂ capture composition includes at least 25% by weight PEP variant and up to about 75% by weight PEP variant, such as about 30% to about 60% by weight, about 35% to about 55% by weight, or about 40% to about 50% by weight. The CO₂ composition can include about 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63% by weight, or more PEP variant according to Formula I. At least a portion, e.g., 50% or more of the PEP variant can be dissolved in the liquid vehicle/carrier.

In some cases, the PEP variant according to Formula I is present in or on a solid support, such as a porous oxide support, porous framework (e.g., Metal-Organic Framework (MOF) or Covalent-Organic Framework (COF)) or incorporated into a resin or polymer, such as an intrinsically microporous polymer. The solid support can be a monolith, a particulate, a powder, a film, membrane (free standing or supported), rolled sheet, or a fiber (e.g., a hollow fiber or electrospun), suitable for use in Carbon Capture Systems.

### C. Methods of Using the PEP Variant

Embodiments of the present disclosure describe methods of using the PEP variant for carbon capture from a feed stream. The PEP variant according to Formula I can be used in place of an amine-based solvent to capture CO₂ from the CO₂-containing feed stream (gas). In an example, the feed stream is flue gas.

The method can include contacting the gas with the PEP variant composition (absorbent or solvent) to capture CO₂ contained in the feed gas. In an example, the absorbent/solvent can be water. The PEP variant composition or solvent can be present as an aqueous solution at an ambient temperature (outdoor air temperature) for direct air capture (DAC). An example ambient temperature range is from −40° C. to 40° C., another example ambient range is from 10° C. to 30° C. The ambient temperature is the initial temperature at contact of the PEP variant composition with the feed gas. The temperature can subsequently rise given that the capture reaction is exothermic. For flue gas, the capture temperature can be higher—for example, 40° C. A range for flue gas capture can be between 30° C. and 100° C. The pressure for gas capture can be in the range of from 1 to 50 bar and can commonly be achieved at pressures of around 1 bar. In pressurized systems, capture of gas can occur at pressures in the range of from 10 to 30 bar, and in an example, around 20 bar. It is recognized that the operating temperature and pressure for capture can vary depending, in part, on the source of the feed gas.

Although the focus of the present disclosure is on carbon capture, the method can optionally include releasing the absorbed CO₂ from the PEP variant/absorbent and recovering or regenerating the absorbent. The releasing step can include a change in temperature and/or pressure. For amine-based absorbents, the release temperature can be around 120° C. For the PEP variant described herein, the release temperature can be between 80° C. and 150° C. The release pressure can be between 1 and 150 bar and can commonly be achieved at pressures around 1 to 2.5 bar. In pressurized systems, release can occur at pressures in the range of from 5 to 30 bar, and in an example, around 20 bar.

Note that a change (or swing) in the temperature or pressure can facilitate release of CO₂. In the releasing step, there can be an increase in temperature or a decrease in pressure, relative to the capture step. In other examples, a decrease in temperature or an increase in pressure can be used to facilitate releasing CO₂. Temperature and pressure swings are commonly used for absorbers and strippers.

Upon releasing CO₂, the CO₂ can be compressed. In an example, liquefied CO₂ can be pumped into wells for long term storage.

The PEP variant can capture CO₂ in a single step that can be reversible without the use of enzymes. The PEP variant can capture CO₂ in a single phosphate-bicarbonate exchange, without changing the organic portion of the PEP variant. Thus, in the regeneration/release step, the exchange is reversed, and the PEP variant is returned to its original structure.

### D. Devices/Systems for Use of the PEP Variant

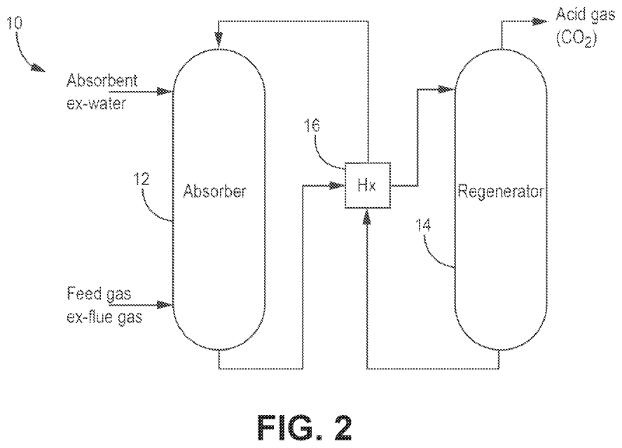

Embodiments of the present disclosure describe devices and systems for using the PEP variant for carbon capture. FIG. 2 provides a system 10 for performing the method of carbon capture described above. The system 10 can include an absorber 12 and a regenerator 14. The absorber 12 can facilitate the capture of CO₂ from a feed gas (e.g., flue gas). Operating conditions of the absorber 12 can depend, in part, on a composition of the feed gas and the absorbent (including CO₂ concentration in the feed gas and a concentration of the absorbent in solution), as well as a temperature and pressure of the feed gas and absorbent. Exemplary ranges for operating temperatures and pressures for CO₂ capture are provided above under the method.

The regenerator 14 can facilitate the release of CO₂ from the absorbent/solvent such that the absorbent can be recycled to the absorber 12 for reuse. The regenerator 14 can include a stripper and a reboiler. The CO₂ containing absorbent can release (desorb) the CO₂ using a gas, such as steam. Operating conditions of the regenerator 14 can depend, in part, on at least the factors provided above in regard to the absorber 12 in terms of the feed gas and absorbent. Exemplary ranges for operating temperatures and pressures for CO₂ release are provided above under the method.

The system 10 can also include a heat exchanger 16 to exchange heat between the CO₂-containing absorbent exiting the absorber 12 and the regenerated absorbent exiting the regenerator 14, before the regenerated absorbent is recirculated back into the absorber 12. Specifically, the regenerated absorbent can transfer heat to the CO₂-containing absorbent to increase the temperature of the CO₂-containing absorbent to operating temperatures of the stripper/regenerator 14.

Embodiments of the present disclosure can include the absorber 12 only. The absorber 12 is used to capture CO₂ and remove CO₂ from the feed gas. The captured CO₂/CO₂-containing absorbent can then be disposed of or otherwise treated.

The methods and devices/systems described herein can be used in a variety of applications that can benefit from carbon capture from a feed gas. Such applications can include, but are not limited to, petrochemical, electrical power production, cement, metalworks, and carbon capture and storage (CCS), including fossil-fuel CCS and bioenergy with CCS (BECCS).

The following Examples are intended to illustrate the above invention and should not be construed as to narrow its scope. One skilled in the art will readily recognize that the Examiners suggest many other ways in which the invention could be practiced. It should be understood that numerous variations and modifications may be made while remaining within the scope of the invention.

### EXAMPLES

These Examples are for illustrative purposes and are not meant to be limiting on the scope of the appended embodiments. The numerical values set forth in the specific examples are reported as precisely as possible; yet errors necessarily result from the standard deviation found in their respective testing measurements.

An initial assessment of the suitability of PEP and similar compounds (i.e., PEP variants) as PCC solvents was performed using group contribution methods to estimate the reaction enthalpies to determine if they fall within the optimal range derived from process modeling of standard absorber/stripper architectures discussed above. For compounds found to be in the optimal enthalpy range, nonreactive molecular dynamics simulations were performed to quantify their aqueous solution properties, like solubility, viscosity, and diffusivity. Furthermore, reactive molecular dynamics was used in conjunction with quantum mechanical calculations to simulate the energetics and kinetics of reaction with the bicarbonate ion. The assessment identified compounds with the largest confluence of optimal properties. These were fed back through the process model to evaluate the net reduction in energy penalty relative to the amine benchmark.

It is well understood that intermolecular forces are determined by the properties of the atoms and bonds making up the molecules and that these, in turn, determine macroscopic properties. This is the basis of group contribution methods wherein weighting factors are assigned to the atoms, atomic groups and bonds constituting a given molecule and these values algebraically summed to estimate certain properties of the molecule. The most accurate methods at the limit of estimation also allow for nearest neighbor and next nearest neighbor interactions of the atoms and functional groups comprising the molecule of interest to factor into the overall sum. The method of Benson is an example and is the basis of the American Society for Testing and Materials Chemical Thermodynamic and Energy Release Evaluation (CHEETAH) program distributed by the National Institute of Standards and Technology and widely used in industry. In the current work, CHEETAH was used to estimate the enthalpies of formation ΔH_{f} for the various reactants and products in the reaction of phosphoenol compounds with bicarbonate according to the generalized and balanced reaction equation given below:

$${R C R}^{′} {{{PO}_{4}}^{2 -}}_{( aq )} + {{{HCO}_{3}}^{-}}_{( aq )} ↔ {R C}_{2} {H R}^{′} {{{O}_{3}}^{-}}_{( aq )} + {{{HPO}_{4}}^{2 -}}_{( aq )}$$

The reaction enthalpy ΔHᵣₓₙ was then be calculated as the difference in the stoichiometric sum of formation energies between the products and reactants according to:

$$Δ {H}_{rxn}^{o} = \sum Δ {H}_{f}^{o} ( products ) - \sum Δ {H}_{f}^{o} ( reactants ) .$$

These calculations were repeated as the molecular structure of PEP was varied to determine the sign, magnitude, and trends in the reaction enthalpy of CO₂ capture. The phosphoenol backbone depicted below was held constant while the variables R and R′ were changed by adding functional groups ranging from a simple hydrogen atom to increasingly more complex chemical structures like alkenes, alkynes, aryls and ketoacids. The nomenclature in what follows simply hyphenates the phosphoenol backbone with the added functional group, e.g., phosphoenol-alkenes, where R and R′ could be any number of different alkenes and alkene derivatives, as described above. For PEP, R is a carboxylate anion CHO₂⁻ while R′ is a methyl group CH₂.

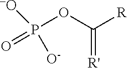

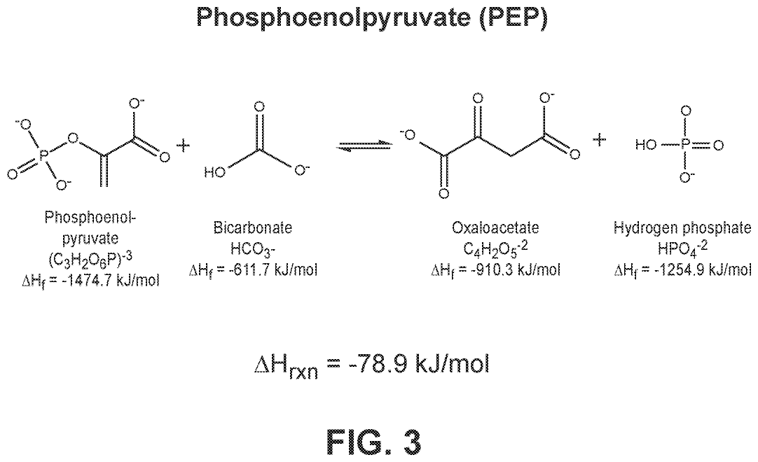

Starting with PEP—which belongs to the phosphoenol-ketoacid group where ketoacids consist of both a carboxylic acid (O═R—O⁻) and ketone (R—C═O) group —FIG. 3 shows the enthalpy of formation for the reactants and products and the overall enthalpy of reaction AHOfn. The PEP-HCO₃— reaction already has enthalpy within the optimal range of −80±20 kJ/mol even before modifying its chemical structure.

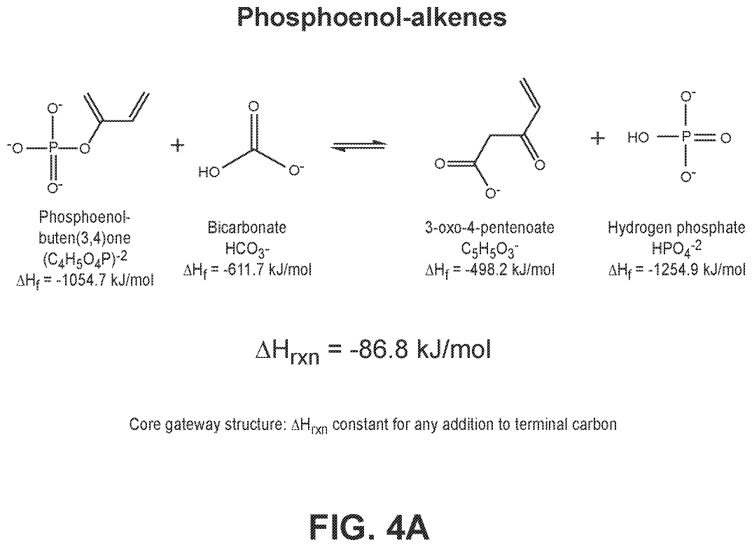

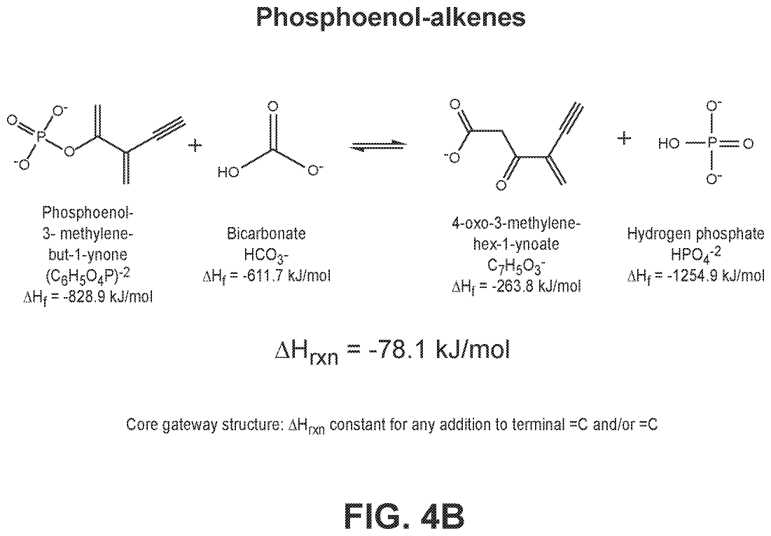

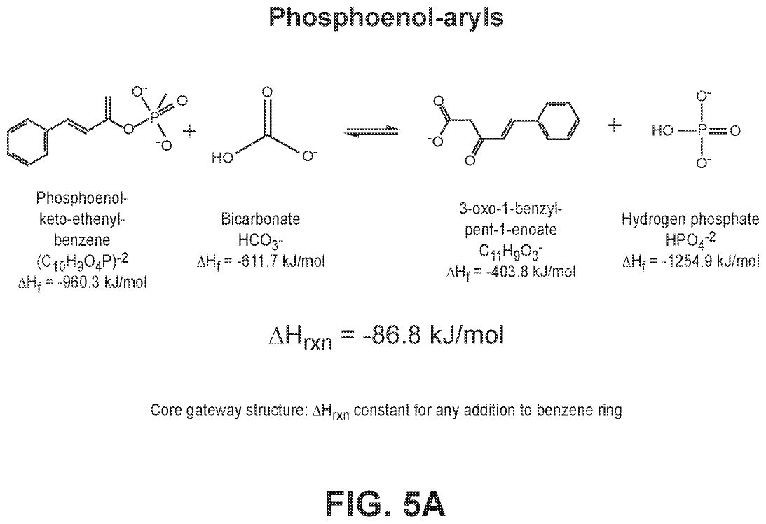

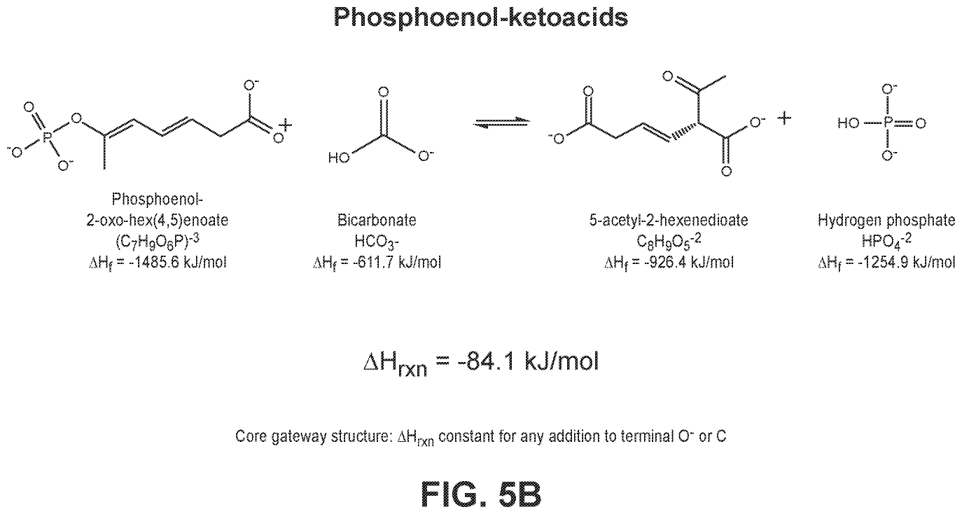

Similar data are shown in FIGS. 4A, 4B, 5A and 5B for simple alkene, alkyne, aryl, and ketoacid additions to the core phosphoenol structure. Again, reaction enthalpies fall within the target range. More interesting, however, is that these compounds represent core gateway structures where any number of additional atoms and/or functional groups can be added to the terminal carbons of these structures without changing the reaction enthalpies. The reason being that the functional groups were added far from the reactive sites and thus do not contribute to the nearest and next-nearest neighbor weighting factors applied to the reactive atoms. Therefore, contributions from the additional functional groups simply cancel out when calculating ΔHᵣₓₙ^{o}. This opens the gateway to countless possible phosphoenol compounds with optimal reaction enthalpies.

First approach estimates of reaction enthalpies via group contribution for reaction of phosphoenol compounds with bicarbonate revealed (i) core gateway structures that can be built upon with any number of different atoms and/or functional groups to customize molecular properties without changing reaction enthalpy and (ii) that these reaction enthalpies are within the optimal range for use as solvents in absorption-based PCC.

### Example 1: Atomistic Molecular Dynamics Simulations

These investigations were carried out using non-reactive molecular dynamic (MD) simulations. The General Assisted Model Building with Energy Refinement (AMBER) Force Field (gAff) was used to parameterize molecules for the simulation because it is applicable to modeling interactions of small organic compounds, including PEP. The simulations were performed using the Large-scale Atomic/Molecular Massively Parallel Simulator (LAMMPS), which is a molecular dynamics program from Sandia National Laboratories.

All simulations were established by organizing the necessary molecules periodically in a specified simulation box. Each system was run a total of six times with the orientations of the molecules randomized in each version. The molecules were situated approximately 6 Å away from each other to avoid collisions during set up. At the onset of each simulation, the energy of the system was minimized, thus reducing the size of the system. After this minimization, a Maxwell Boltzmann distribution was utilized to randomly assign kinetic energies to the molecules based on temperature. The system was then allowed to equilibrate for one nanosecond. Measurements were taken over a 10-nanosecond period following equilibration.

All simulations were run at typical absorber conditions of 40° C. and 1 atm. All bonds and angles were treated as harmonic, and water molecules were treated as rigid bodies to prevent angular vibrations. These simplifications were included because this investigation was focused on solution properties as a whole and the exact form of molecular deformations is therefore negligible. Table 1 describes the concentration of PEP/water mixtures studied by MD.

### Dissociation of Acids

Non-reactive MD is unable to simulate the dissociation of an acid, therefore it is necessary to place the appropriate number of “pre-dissociated” ions in the simulation during setup. The runtime of a few nanoseconds is often insufficient for free protons to move away from their conjugate bases, as this process requires water molecules to interpose themselves between the charges. Therefore, hydronium ions (H₃O⁺) were randomly distributed across the system during setup and a set of independent simulations were performed with different proton distributions. Since only the first dissociation constant (Kₐ) for PEP is available in the literature, only singly charged PEP molecules were considered.

C₃H₅O₆P+H₂O→C₃H₄O₆P⁻+H₃O⁺

It was assumed that it was significantly more difficult for a PEP ion to lose its second or third hydrogen, as that would result in multiple like charges on the same molecule. Even if triply charged PEP would more accurately represent the state in solution than the singly charged state, results are conservative since the triply charged state is likely to be more soluble. Less than half of the PEP molecules in the solution were dissociated at modeled conditions. However, for the simulations including bicarbonate, a much higher pH was assumed, and essentially all PEP molecules were dissociated. It seems likely that under these conditions, doubly and possibly triply dissociated PEP ions would have been present, which decreases bond dissociation energies and decomposition barriers as shown later via reactive MD simulations.

TABLE 1
Simulation Parameters for PEP Modeling

| | | | | # Water | |
|---|---|---|---|---|---|
| | | | | molecules | |
| wt % | # PEP | # PEP⁺ | # Water | difference to | Initial Box |
| PEP | molecules | Ions | molecules | baseline | Size (Å) |
| 31.93 | 92 | 408 | 9940 | +2795 | 136.4 |
| 39.49 | 113 | 387 | 7145 | NA | 124.0 |
| (Baseline) | | | | | |
| 45.38 | 129 | 371 | 5612 | −1533 | 117.8 |
| 48.23 | 137 | 363 | 5005 | −2140 | 111.6 |
| 49.49 | 141 | 359 | 4759 | −2386 | 111.6 |
| 50.41 | 144 | 356 | 4587 | −2558 | 111.6 |
| 51.76 | 148 | 352 | 4346 | −2799 | 105.4 |
| 52.77 | 150 | 350 | 4173 | −2972 | 105.4 |
| 54.62 | 156 | 344 | 3874 | −3271 | 105.4 |
| 56.64 | 162 | 338 | 3569 | −3576 | 99.2 |
| 58.81 | 168 | 332 | 3266 | −3879 | 99.2 |
| 59.99 | 172 | 328 | 3110 | −4035 | 99.2 |

### Estimation of Solubility Via Energy of Mixing

The solubility of PEP is key to its energy-efficient use for PCC. The solubility was estimated by constructing a potential energy versus concentration curve in addition to the entropy of solution effects, which were approximated as an ideal solution by:

$$S = - {R}_{χ} {ln}_{χ}$$

where χ is the mole fraction of PEP in solution. The energy of mixing is:

$$U = Thermal Energy + Interaction Energy$$

$$Energy change by mixing = {U}_{3 , solute \& N + M water} - ( {U}_{1 , solute \& N water} + {U}_{2 , M water} )$$

Additionally, pure water simulations were performed to calculate the difference in energy caused by simply changing the number of water molecules. This allows for the direct comparison of energy between various simulations.

$${U}_{3} - {U}_{1} - {U}_{2} = Δ Interaction Energy$$

### Benchmarks and Validation

Benchmark materials were used to check the accuracy of the simulation method. Acetic and formic acids were chosen as the initial benchmarks due to readily available literature values on their solution enthalpy. The enthalpy of mixing was calculated in a similar manner to the free energy of mixing, using the default LAMMPS enthalpy calculation. Simulations were run for 3, 4, and 5 mol/L of both materials. Comparative results between literature and calculated values are shown in Table 2; all values are reported at kJ/mol. Although the solubility trends are well reproduced, the values are not quantitative. This was expected for the simple approach taken here, which nonetheless proved sufficient.

TABLE 2
Enthalpy of Solution for Acetic and Formic Acid (k.J/mol)

| Acetic | | | Formic | | |
|---|---|---|---|---|---|
| Acid | Literature | Calculated | Acid | | Calculated |
| mol/L | value | Value | mol/L | Literature | Value |
| 3 m to | −0.193 | −0.283 | 3 m to | 0.000 | −0.093 |
| 4 m | | | 4 m | | |
| 4 m to | −0.368 | −0.543 | 4 m to | 0.000 | −0.127 |
| 5 m | | | 5 m | | |
| 3 m to | −0.175 | −0.061 | 3 m to | 0.000 | −0.104 |
| 5 m | | | 5 m | | |

### Simulation for 30% by Weight Aqueous Monoethanolamine Solution

MD simulations with 30% (by weight) aqueous monoethanolamine (MEA) solution (500 MEA molecules, 3955 water) were also performed to directly compare predicted performance measures of PEP against the current industry standard. These simulations were performed under the same conditions and with the same forcefield as the PEP simulations.

### Radial Distribution Functions

The system's radial distribution functions (RDFs), which are statistical mechanics descriptions of how density varies as a function of distance from a reference point, determine solution structure. The water position was defined by the oxygen atom; the inset of FIG. 5A shows the PEP centers. RDFs were normalized by density so that they converged to one at large distance.

### Diffusion

The diffusivity of PEP in solution D was found via the Stokes-Einstein equation.

$$D = {lim}_{Δ t \to 0} \frac{1}{6 Δ t} 〈 {[ x ( t + Δ t ) - x ( t ) ]}^{2} 〉$$

Mean squared displacement data were obtained every 5 picoseconds from trajectories. Diffusivity is important in the PCC process because it influences the kinetics of the PEP-bicarbonate reaction, which essentially determines the speed of CO₂ absorption. An additional simulation was performed to find the diffusivity of bicarbonate in an equilibrium PEP-water solution. For this simulation, the optimum PEP concentration was used (48.23 wt %), and the pH was set to 1.5 to allow PEP to fully dissociate and enough bicarbonate to form in solution to obtain meaningful statistics. In a realistic system, the number of PEP ions would be the same but most counter ions would be sodium (Na⁺) instead of H₃O⁺. However, the simulation is nonreactive, meaning molecules cannot react, so there is no significant difference since PEP concentration governs the results.

### Viscosity

The shear viscosity of a liquid can be computed through several different atomistic simulation methods. The Green-Kubo relation was used to calculate the viscosity of the specified systems because it can be used on any equilibrated liquid and is easily implemented in LAMMPS. A running average of the viscosity was periodically revised every 3 picoseconds using this technique. In this method, the shear viscosity is obtained from the integral over time of the pressure tensor autocorrelation function:

$$η = \frac{V}{{k}_{B} T} {{\int }^{∞}}_{0} 〈 {P}_{xy} ( 0 ) {P}_{xy} ( t ) 〉 dt$$

where V is the volume of the system, k_{B} is the Boltzmann constant, T is temperature, Pxy denotes the element xy of the pressure tensor, and the angle bracket refers to the ensemble average. Viscosity plays an important role in pumping costs for moving aqueous PEP solutions between the absorber and stripper. To contrast aqueous PEP solutions with the current amine-based benchmark, a simulation of 30 wt % MEA was run to find its viscosity.

### Results

### Energy of Mixing

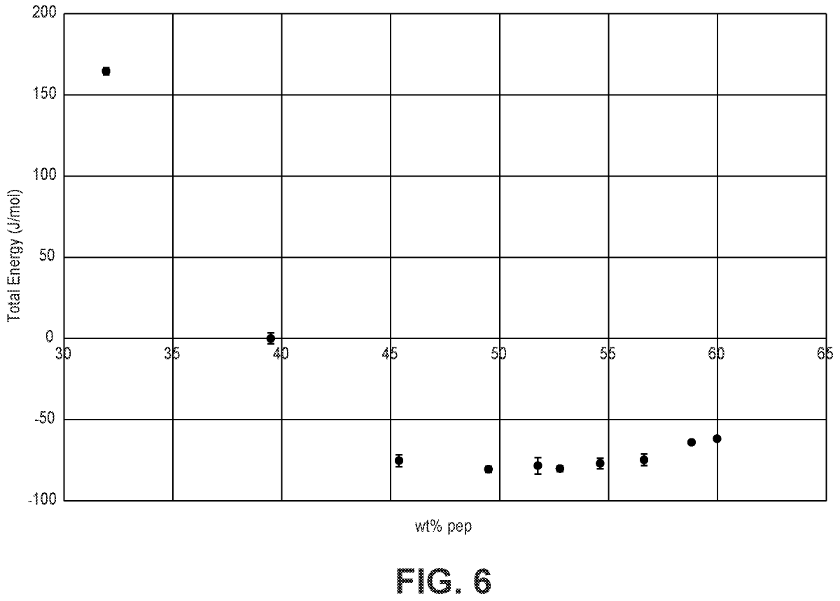

A solubility curve for aqueous PEP solutions is shown in FIG. 6 and demonstrates the expected features. As PEP is charged and polar, it has an energy minimum at a high concentration of about 50 wt % in water, which corresponds to a mole fraction of about 10%. This puts it slightly below the commonly used MEA concentration of 11%. Mixing energy plateaus between 45% and 55%, which may indicate that this mole fraction could be somewhat higher at small energy penalty. The wide energy minimum is indicative of good solubility over a range of conditions.

### Solution Structure and Radial Distribution Functions

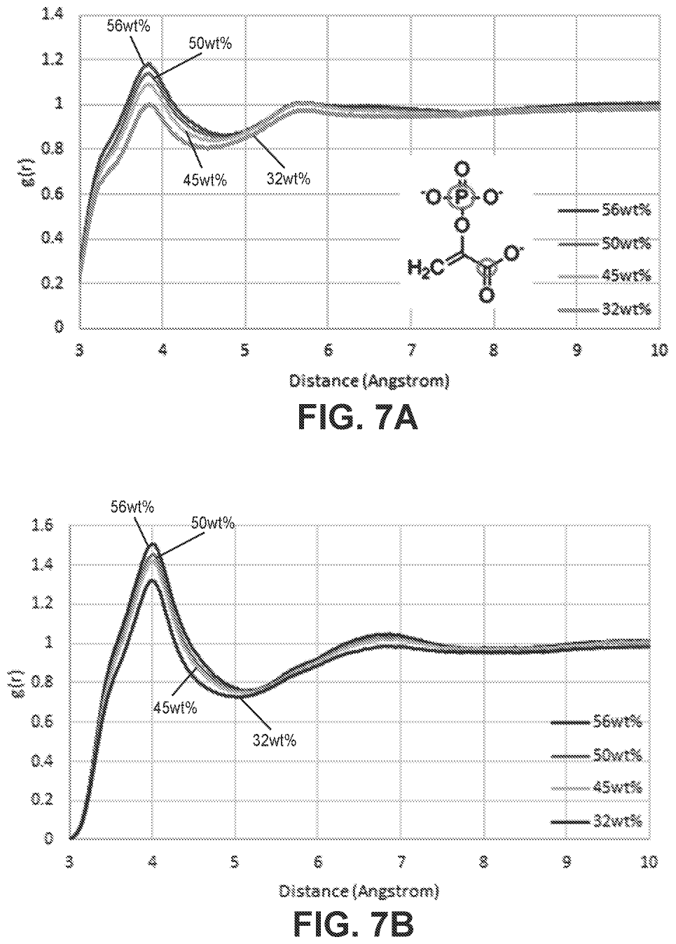

As the PEP concentration of the solution increases, no significant structural changes were observed in the radial distribution functions (RDF) of water around PEP, as shown in FIG. 7A for carbon and in FIG. 7B for phosphorous. There is a trend of increasing magnitude of mainly the first peak in the RDF as concentration is increased. This is likely due to the higher concentration simulations having fewer waters, resulting in increasingly large portions of the total water in PEP hydration shells and indicating a slightly better solubility of PEP with decreasing water. The lack of any significant change in RDF implies that the structure of the hydration shells was the same across the entire range of concentrations and correspondingly that the solvation mechanism is unchanged. No indications of structural transition or unmixing were observed.

### Viscosity

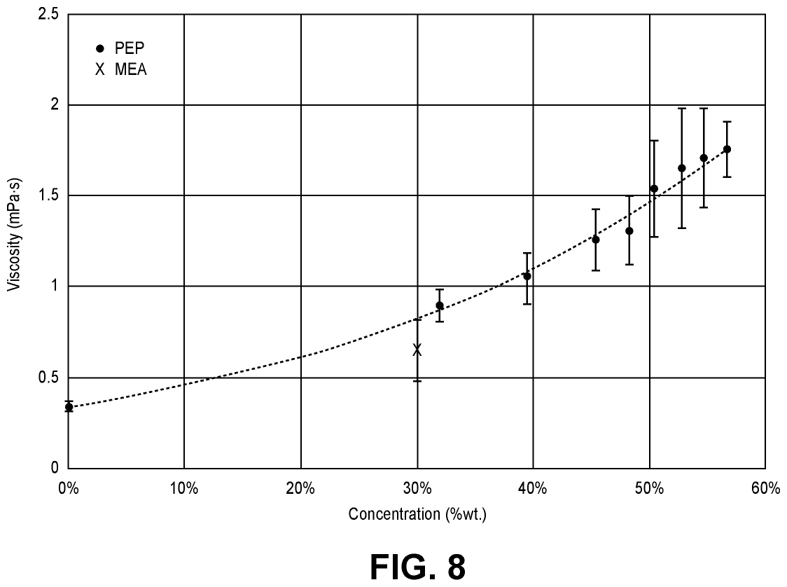

FIG. 8 shows viscosity as a function of % wt. aqueous PEP concentration determined using the Green-Kubo relation. The values obtained were about 50% below the experimentally expected value where available. This is not unusual for simulations of this type. Thus, trends were expected to be robust. The value obtained for pure water was 0.342 millipascal-second (mPa·s), whereas its expected value is around 0.79. Simulations of a 30% wt. aqueous MEA solution were also performed to compare relative numbers and was found to have a value of 0.647 mPa*s.

### Diffusion Coefficient

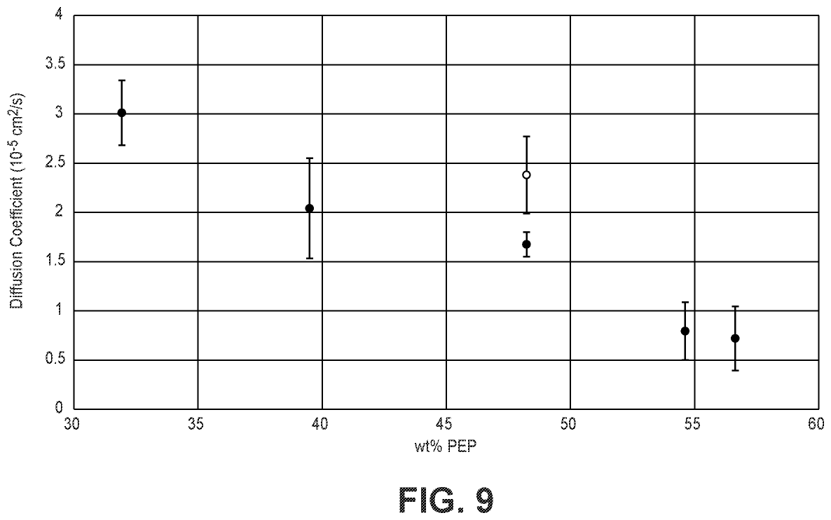

The mean square displacement over time was used to calculate the diffusion coefficient of PEP over a range of concentrations. FIG. 9 shows the diffusion coefficient as a function of the PEP concentration ranging from 30 to 60% weight. At 48 wt % PEP, bicarbonate was determined to have a diffusion coefficient of 2.381±0.392×10⁻⁵ cm²/s, roughly a third of its literature value for pure water (shown as orange dot in FIG. 9).

Bicarbonate transport was also included in the simulations. The bicarbonate concentration was calculated according to:

$$[ {HCO}_{3}^{-} ] = \frac{{K}_{c 1} {H}_{{CO}_{2}} {p}_{{CO}_{2}}}{[ {H}^{+} ]} .$$

Values for constants were taken from the literature. The equilibrium constant K_{c1} had a value of 2.5×10⁻⁴, and the Henry's law constant for CO₂ is approximately 0.034 mol/L atm at neutral pH value. The mole fraction of CO₂ was 0.205 based on the assumption that all oxygen in the air had been converted to CO₂ in the combustion process.

Due to the concentration of HCO₃⁻ being very low at low pH value (explicit pH was 1.5 for the PEP simulations), it was necessary to significantly raise the pH of these simulations to have a useful concentration of bicarbonate at a reasonable simulation size. It was expected that all PEP molecules would likely have at least one dissociated proton and a significant amount would have more. But due to the limitations mentioned previously, only singly charged ions could be simulated; simulation parameters are shown in Table 3.

TABLE 3
Diffusion Coefficient Simulation Parameters

| wt | # Water | # PEP⁺ | # Bicarbonate |
|---|---|---|---|
| % | molecules | ions | molecules |
| 31.93 | 29820 | 1500 | 94 |
| 39.49 | 21435 | 1500 | 69 |
| 48.23 | 15015 | 1500 | 49 |
| 54.62 | 11622 | 1500 | 39 |
| 56.64 | 10707 | 1500 | 37 |

### Free Energy of PEP Variants

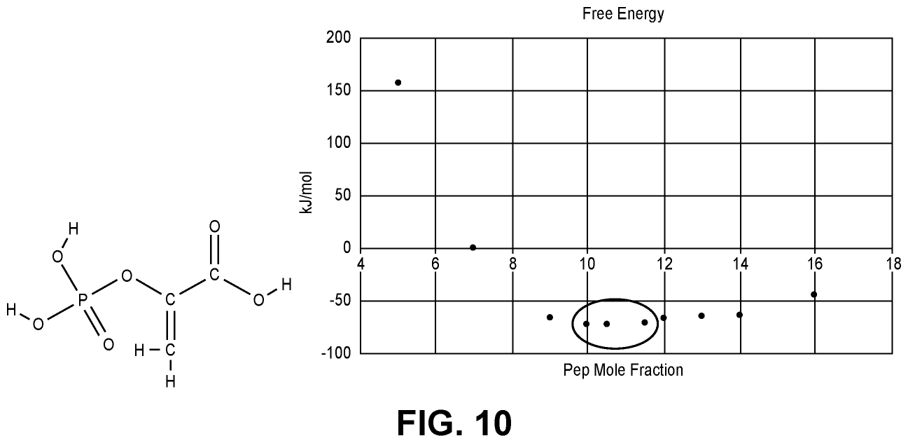

PEP appears to be a suitable replacement for MEA in PCC based on its properties in aqueous solution. However, variations on the PEP structure obtained by removing or adding different atoms and functional groups were tested for even better PCC solvent alternatives. An assessment of exemplary PEP variants is given here. FIG. 10 displays both the original PEP molecule and its free energy diagram. Subsequent analyses of PEP variants are judged solely on the merit of their free energy diagrams compared to that of the original. For the variant to have any advantage over the original PEP molecule, they should have lower energy of dilution in water. For the sake of simplicity, the 3 points enclosed by the red circle in FIG. 10 were the only points compared across all variants since they represent the energy minimum.

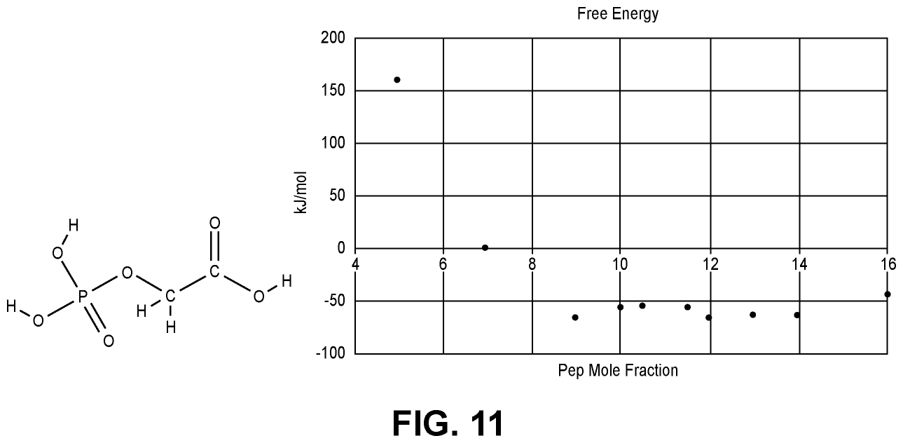

The first PEP variant (C₂H₅O₆P) is depicted in FIG. 11 and eliminates the terminal double bonded carbon. Comparing this free energy diagram with that of PEP demonstrates that it has higher energy of dilution. These simulations do not suggest this variant to be a better replacement to PEP.

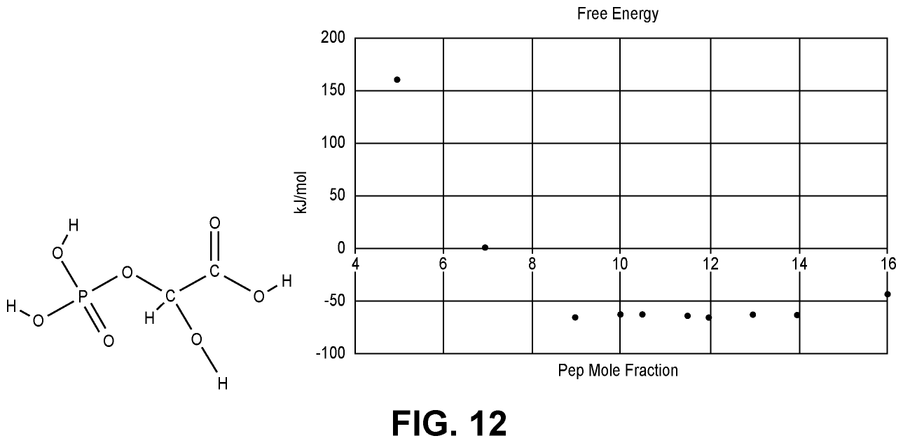

Substituting one of the hydrogen atoms bound to carbon atom C2 with a hydroxyl group, as shown in FIG. 12, also results in higher free energy. Again, this suggests the variant shows no improvements over PEP, although the difference between the curves is small.

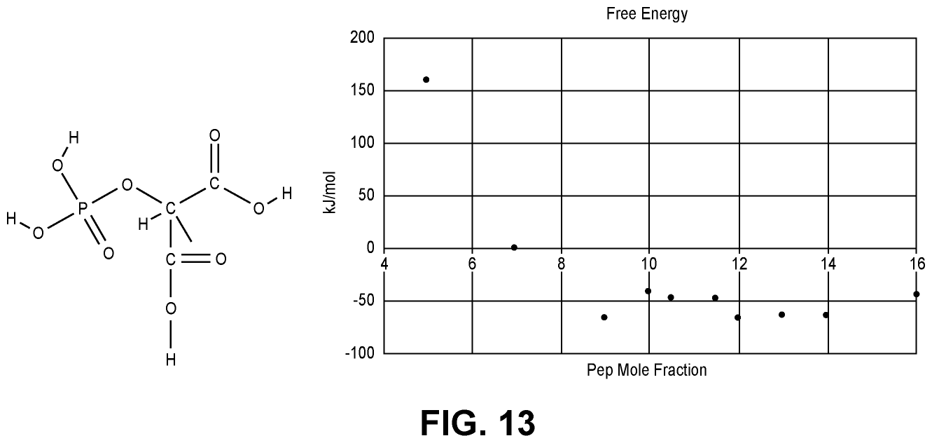

Replacing a hydrogen atom on C2 with a carboxylic acid group (O═C—OH) instead of hydroxyl group increases the energy of dilution even more than the previous two variants, as shown in FIG. 13. It is not immediately clear why the addition of a carboxylic group increases the dilution energy, but without being bound by theory, it may involve steric hindrances to the hydration shell. A possible explanation is that the carboxylic group aids the dissociation of the first proton but makes it more difficult for the second proton to dissociate due to electrostatic attraction to the nearby carboxylate anion.

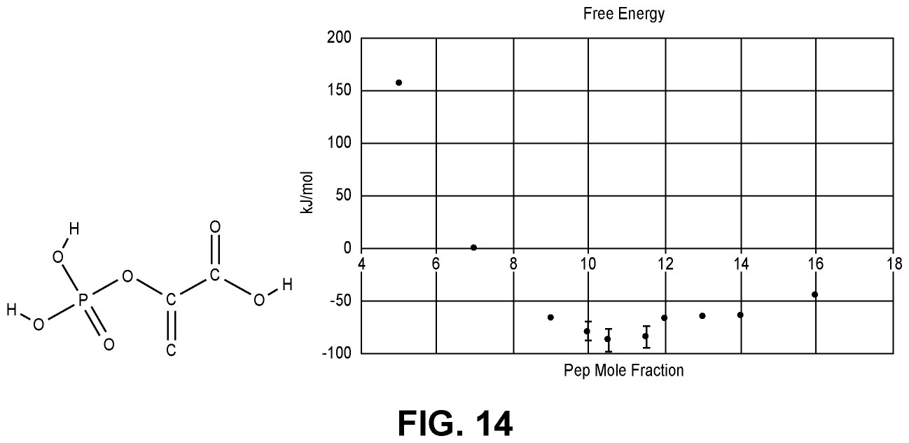

For the fourth PEP variant (C₂H₃O₇P), the hydrogen atom attached to C2 is substituted with a double bonded oxygen (oxy-group). FIG. 14 shows that the energy of dilution is this case is lower than the original PEP molecule. These results demonstrate that the aqueous solution properties of PEP can be improved by changing the functional groups in the nonreacting parts of the molecule.

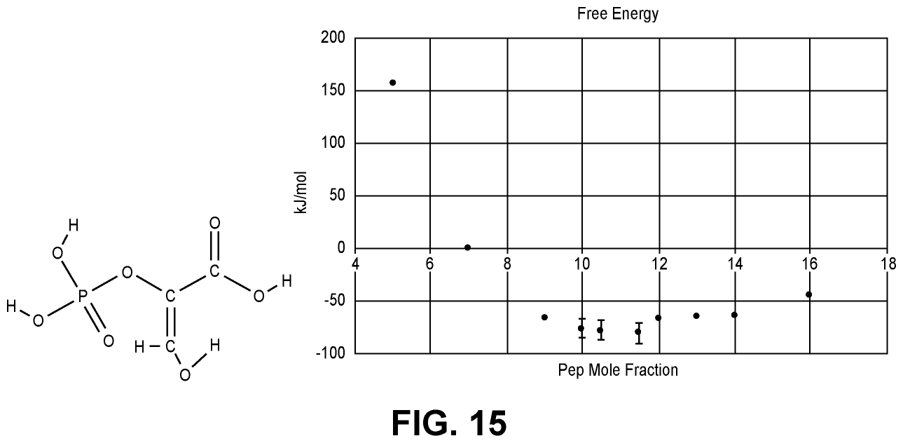

The final PEP variant (C₃H₅O₇P) is shown in FIG. 15, where a carbon atom bonded to a hydroxyl group (C—OH) substitutes the hydrogen on the C2 atom. Like the previous variant but to a lesser extent, the minimum in the energy of dilution is lower than that found in original PEP. Again, this demonstrates the ability to optimize the properties of PEP by modifying the chemical structure of the nonreacting regions.

The chemical potential-concentration curve shows that the expected solubility of PEP at 20° C. is 9.8 mol %. This is slightly lower than the 11 mol % of the standard MEA solution. However, the stoichiometric ratio of MEA to CO₂ during absorption is 2:1 as shown below while that of the PEP-CO₂ reaction is 1:1. Therefore, the absorption capacity of the PEP solvent for CO₂ is almost doubled compared to most primary and secondary amines, which all follow the same general reaction stoichiometric ratio shown below:

CO₂+NHR₂+NR₃↔NR₂CO₂⁻+NR₃H⁺

where NR₃ can be any primary, secondary or tertiary amine and NHR₂ is either a primary or secondary amine. Higher temperatures present in absorber systems may further improve the solubility of PEP, especially given the curve is very shallow up to 55 wt % (11 mol %).

The viscosity of the PEP solution in the 45 to 55 wt % (9.8 mol %) range was estimated to be roughly triple that of the standard MEA solution, with a real viscosity of about 3 mPa*s. Based on the viscosity alone, a rough calculation shows that the same pipe infrastructure would require about 6% more power to pump PEP solution than MEA solution. Fortunately, the amount of power required to pump MEA is already a negligibly small part of the PCC energy cost.

Hydration shells, viscosity, and self-diffusion coefficient trends for PEP showed no notable behavior change over the examined range of concentrations. It is therefore unlikely that any sort of relevant phase or structure change is taking place.

In total, the observations made here show the promise of alternative PCC solvents based on phosphoenol compounds to increase the desired solvent properties relative to benchmark amines such as MEA.

### Example 2: Reactive Molecular Dynamics Simulations

The above results suggest that PEP or PEP variants can be reasonably expected be good alternative CO₂ solvents for lower regenerative energy. The reaction mechanism of PEP and PEP variants with CO₂ was accomplished by reactive MD simulations, which use empirical reactive force fields that allow bond formation and dissociation. The reactive force field (ReaxFF) uses an interatomic potential which implicitly describes chemical bonding using a bond-order formulism without explicit quantum mechanical (QM) calculations and thus can handle the dynamics of larger systems than pure QM simulation. In terms of molecular size, PEP and PEP variants are closest to glycine.

This Example presents an optimized ReaxFF for aqueous PEP solutions with CO₂. Force fields were computationally trained against an extensive data set including density functional theory (DFT) calculations of reaction pathways of the dissociation of PEP³⁻, bond dissociation energies, and structures and partial charges of all molecules and ions. The parametrization process utilized a parallelized search algorithm developed at the University of California, Davis.

### Methods

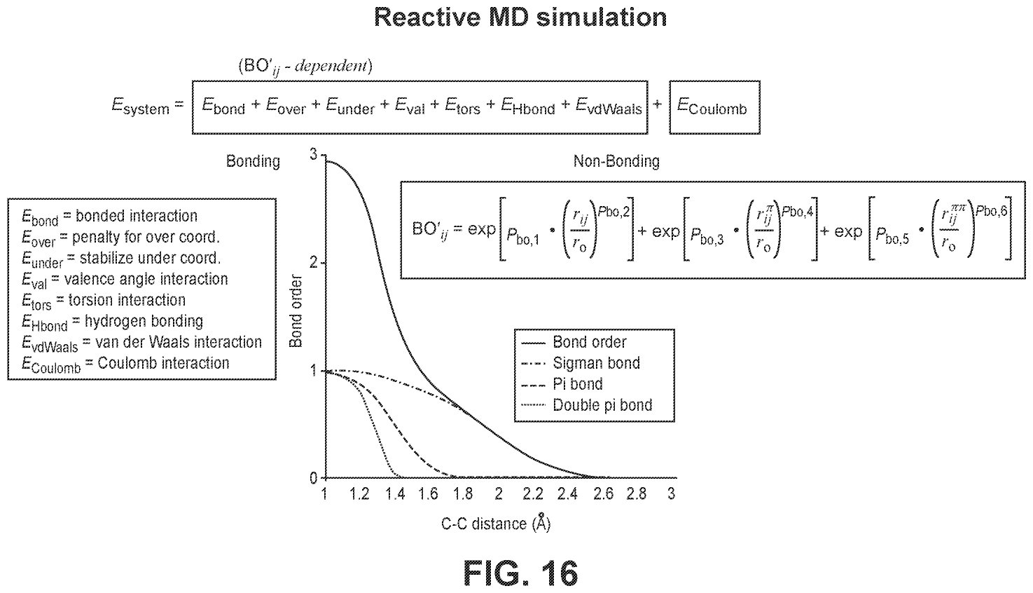

Quantum chemistry-based methods including DFT are powerful tools to describe chemical reactions on the atomistic scale. However, these types of calculations are very computationally expensive and thus limit the time and length scales. Alternatively, empirical force field methods like classical molecular dynamics (MD) simulation can study the system's dynamic evolution for comparatively long times (nanoseconds) with thousands of atoms but loses the reaction information since the atomic connectivity is predefined. Therefore, to describe the reaction step of PEP with HCO₃⁻ (FIG. 3) and compare potential PEP variants, ReaxFF-based reactive MD simulation were used that fill the gap between quantum chemistry methods and classical empirical force field methods. ReaxFF is a reactive force field that allows bond formation and dissociation. The total system energy is comprised of bond order (BO) dependent energies and non-bonded energies, as shown in FIG. 16. Bond order is a smooth function of atom distance. For example, as two carbon atoms starting from close to each other separate further and further, the bond order gradually goes from three (triple bond) to zero (fully dissociated).

The ReaxFF force field P/N/C/O/H/Na was previously published for CO₂ capture using the ionic liquid tetrabutylphosphonium glycinate. The CO₂ related parameters were optimized, and it contains the important element P and the counter ion element Na to neutralize the charged system in the MD simulations. However, the important P—O interactions were not specifically developed, and the H/O parameters were from a 1^{st} generation water force field for which the constant pressure water density is known to be significantly smaller than the experimental value. Furthermore, the H₂O, H₃O⁺, and OH⁻ diffusion constants are more than an order of magnitude off. To improve the accuracy for an aqueous system, all the water related parameters from the P/N/C/O/H/Na force field were replaced with those from the 2^{nd} generation water force field that corrects the 1^{st} generation water parameters. Also, many of the C/P atom parameters and O/P interaction parameters were reoptimized to better describe the PEP-HCO₃⁻ reaction. Table 4 shows which parameters were chosen and why, including their physical importance to the current model system.

TABLE 4
Choice of Forcefield Parameters

| | | Reasons for chosen |
|---|---|---|
| | Parameters Chosen | parameters |
| Electrostatic | Electronegativity equalization | Bonding prediction |
| | method (EEM) parameters | |
| | for C, P | |
| Valence | All bond radii/order/dissociation | Bonding prediction |
| Bond | energy, and under/over | Reaction pathway |
| | coordination energy parameters | Reactant/product/ |
| | for C,P atoms and C-C, | transition state |
| | C-O, P-O pairs | structure |
| Valence | All angle parameters for C, O, P | Geometry prediction |
| Angle | related angles in the molecules | |
| Van der | Vdw radii/dissociation | Bonding prediction |
| Waals | energy/shielding for C, P | |

The optimization process consisted of two parts: training set generation and parallel search algorithm. The new parameter values are accepted so that they reduce the error between training set features and ReaxFF fitted features.

The training set had four sections: charge, geometry, energy and reaction. The charge and geometry sections collect the partial charges, bond lengths, and angles of all the neutral molecules related to PEP-HCO₃⁻ reaction step and their charged states. Since the LAMMPS modeling software being used requires a neutral system, H₃O⁺ were inserted as counter ions. The bond section collected the bond dissociation energy scans for P—O and O—H bonds in neutral PEP and carboxyphosphate.

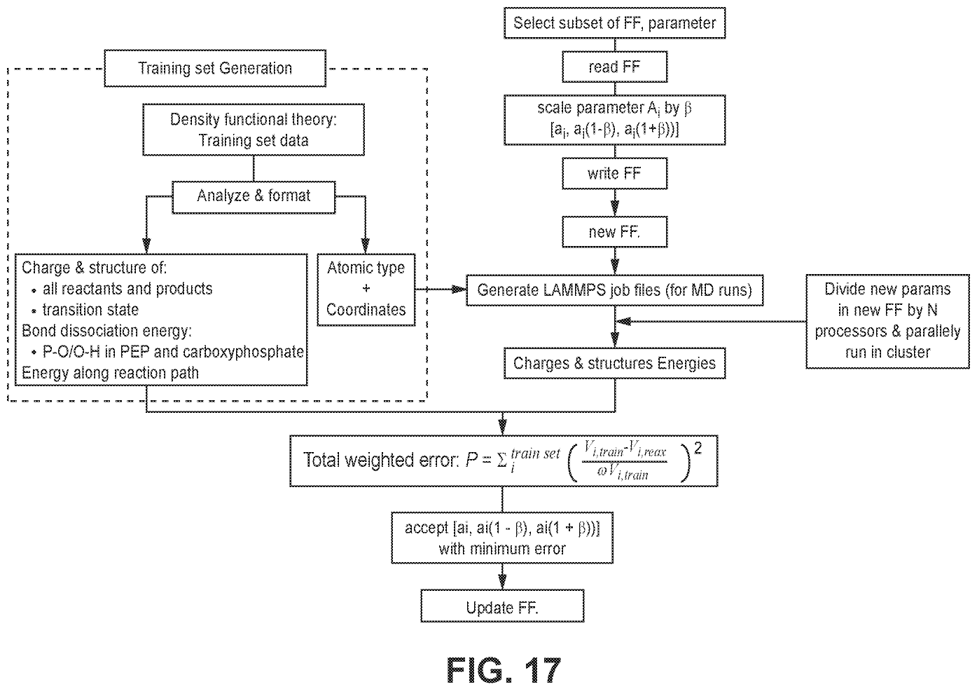

The reaction section had the reaction energy of the PEP-HCO₃⁻ reaction and the activation energy of the splitting of PEP₃⁻ into PO₃²⁻ and the enolate form of pyruvate since the transition state structure of this reaction step is not stable in vacuum. Therefore, this activation energy is not appropriate to include in the training set. FIG. 17 shows the training set features and the workflow of the optimization process. The scripts were written in MATLAB and Bash, and the parallel search optimization part was run in parallel on a high-performance cluster at the University of California, Davis (HPC1). The training set data was from DFT calculations using the Gaussian software, and the MD calculations using ReaxFF were done in LAMMPS. In the total weighted error function, the inverse weight co for each feature in the training set was selected first so that each section of the training set (charge, geometry, energy, reaction) weighs similarly to the error function. Then after the error function converges, the parameters were fine-tuned by changing the weights. This process is repeated until (i) the overall performance of the new force field matches the training set with acceptable errors and (ii) the most important features like kinetics are well matched to the training data.

### Results

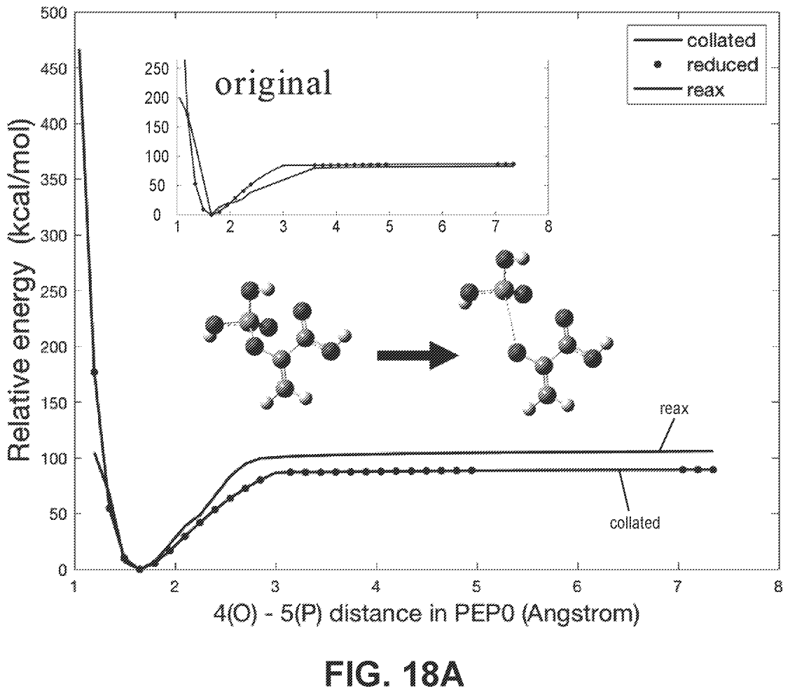

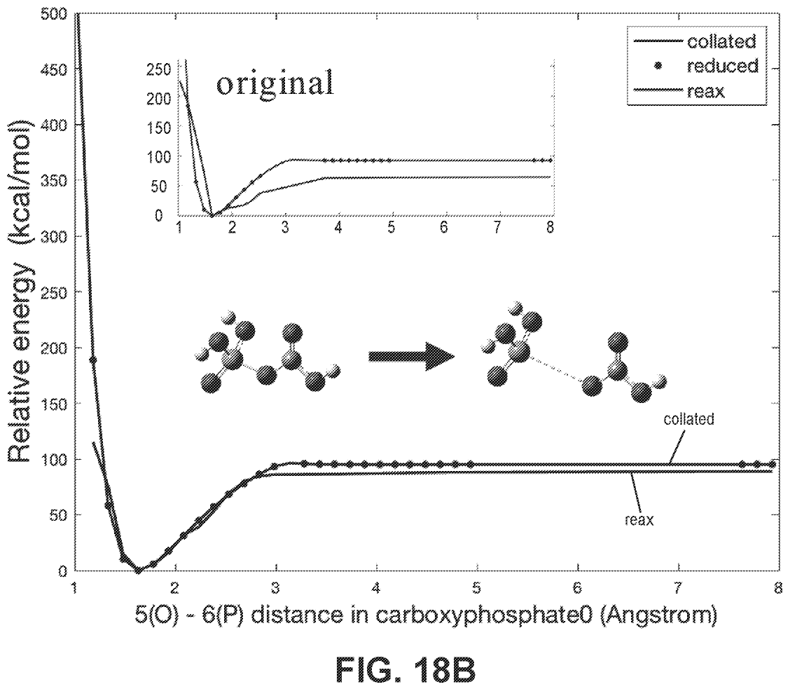

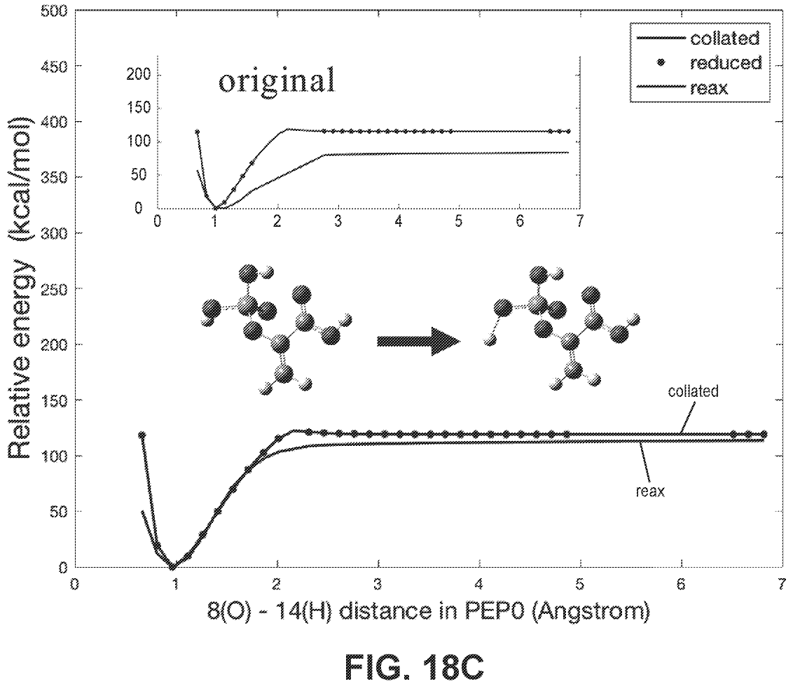

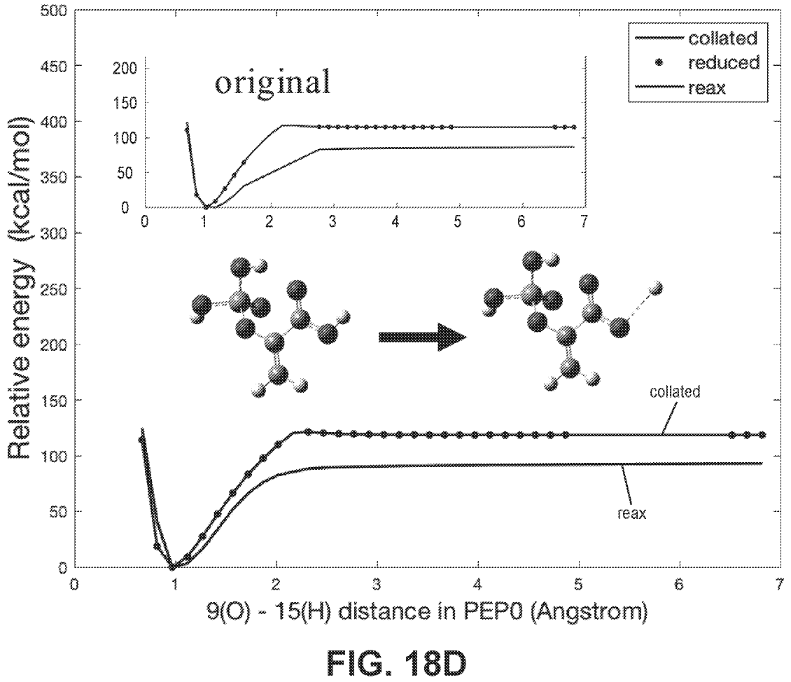

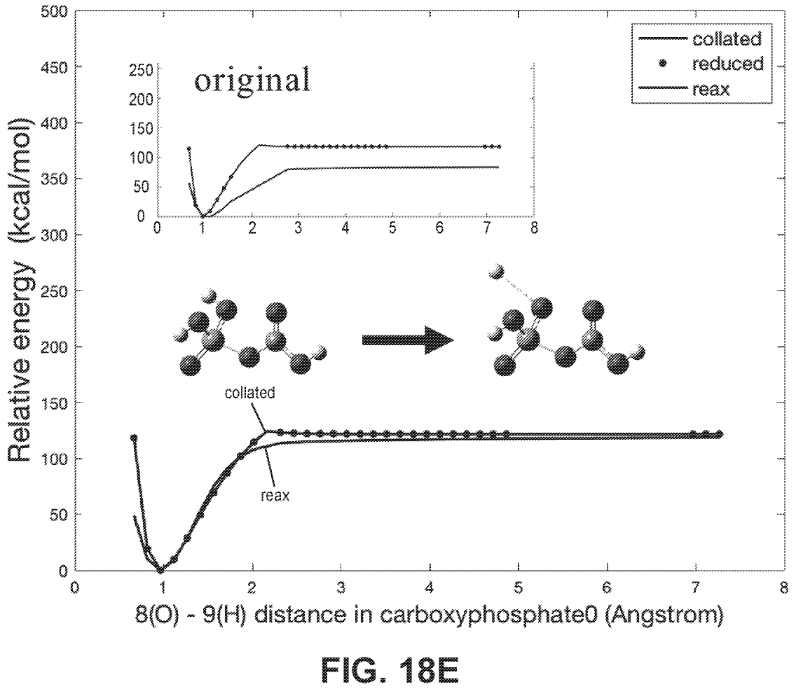

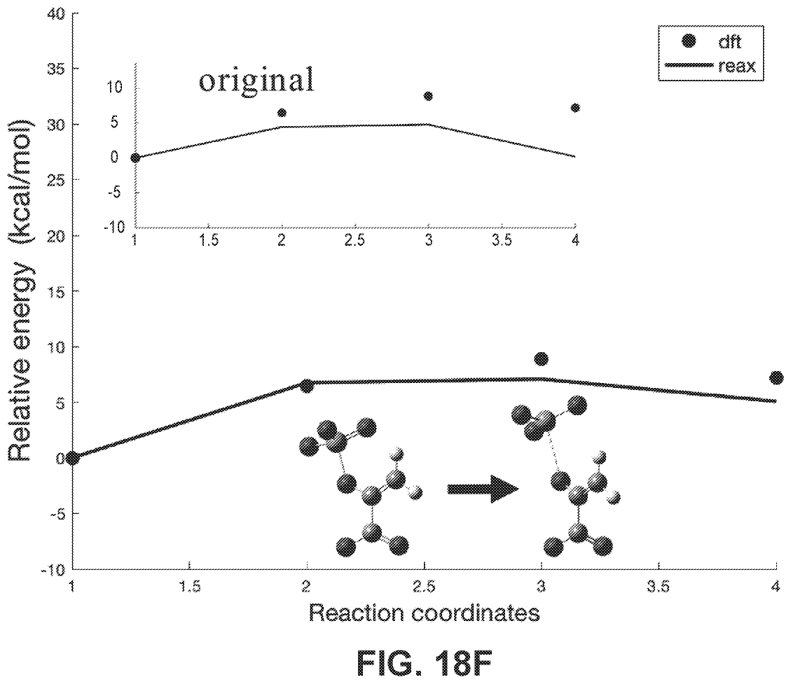

After reoptimizing parameters, as discussed above, the new ReaxFF force field accurately reproduced the partial charges of CO₂, the neutral and charged bicarbonate, PEP, carboxyphosphate, enolate, oxaloacetate, and the transition state relative to DFT values. Bond dissociation energy scans in FIGS. 18A-18F show good agreement between DFT and ReaxFF. Using DFT calculations, the O—P and O—H bonds at the active sites for both neutral PEP and neutral carboxyphosphate were scanned from very short distances to equilibrium distances and then to very large distances without relaxing the whole structure to acquire the energies along the scans. To account for the multiple spin states as molecules break, both singlet and triplet scan were calculated, and the lower energies were taken as bond dissociation scan energies. Some energy data points at extreme distances were removed to reduce the computational cost. The structures corresponding to each DFT data point along the scans were then fed to ReaxFF MD simulations to calculate ReaxFF energies. The fitted ReaxFF energies generally match the DFT energies, especially at the regions near the equilibrium distances.

FIG. 18F shows the comparison of the energies along the reaction pathway and the reaction energy between DFT and ReaxFF. The energies along the reaction pathway were obtained from intrinsic reaction coordinate (IRC) calculation using DFT, and the ReaxFF energies were fitted using for the structures along the DFT IRC curve. The barrier energy from DFT and ReaxFF are 8.87 kcal/mol and 7.08 kcal/mol respectively, and the reaction energy from DFT and ReaxFF are −16.90 kcal/mol and −11.06 kcal/mol respectively. Both the barrier energy and the reaction energy prove that the optimized force field can accurately describe the kinetics and thermodynamics of the PEP-HCO₃⁻ reaction step. Furthermore, the bond and angle errors between ReaxFF and DFT calculations were all less than 6%. All these comparisons show that the optimized ReaxFF force field was PEP and PEP variants.

DFT was used to explore the bond lengths and bond dissociation energies of neutral PEP and PEP variants. As discussed previously, PEP variants are obtained by adding and removing atoms and functional groups from the original PEP molecule to vary the reaction energetics. Using the same two variants shown in FIGS. 14 and 15 or the nonreactive MD simulations above, and an additional variant containing an extra oxygen atom between the central carbon and phosphate group, FIGS. 19A and 19B show the results of these simulations. Although the differences in bond dissociation energies are relatively small, this exercise again demonstrates the ability to alter PEP to obtain other phosphoenol compounds with more favorable properties, e.g. reaction energetics in this case. Of the compounds tested, the variant with a hydroxyl group added to the C2 carbon (V5: ^{a}C₃H₅O₇P) shows the lowest bond dissociation energy, meaning lower reaction energetics and potentially faster reaction kinetics. Note this variant also showed lower minimum energy of dilution than PEP in the nonreactive MD simulations.

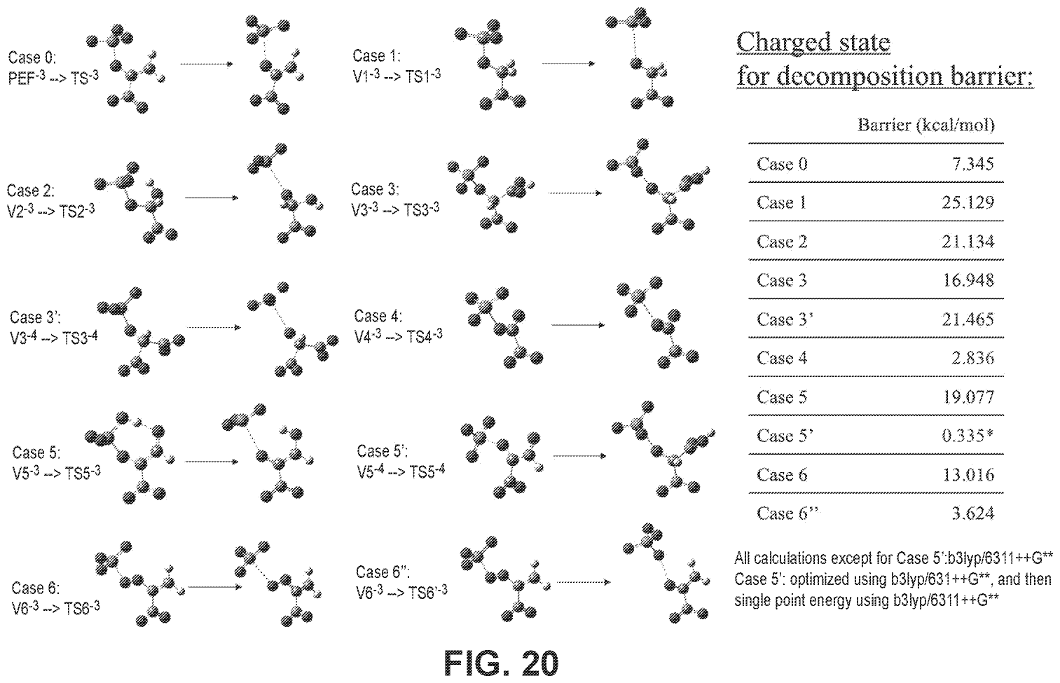

Simulations were similarly performed on the triply charged PEP and PEP variants to evaluate the energy barrier for decomposition into the phosphate and enolate ions, a critical step in the reaction mechanism. Results are shown in FIG. 20. Simulations of the quadruple charged V5 and V6 variants, denoted as Case 5′ and 6′ in the figure, are also included. The effect of modifying the PEP structure and charge on the decomposition barrier energy are striking in this case with several variants showing significantly reduced energy barriers compared to PEP. Of note is the quadruple charged V5 variant with essentially a zero-energy barrier.

The optimized ReaxFF force field reproduced atomic partial charges, geometries, and bond energies of the target reaction exceptionally well. The bond and angle errors between ReaxFF and DFT calculations were all less than 6%. More importantly, the reaction energy and barrier calculated from ReaxFF shows that the optimized force field accurately described the thermodynamics and kinetics of the first step in the PEP-HCO₃⁻ reaction pathway. Water density calculated using this force field and at 300K and latm with isothermal-isobaric ensemble (NPT) is 1.005±0.015 g/cc. Furthermore, first results from simulations of bond dissociation energies and decomposition energy barriers for PEP and PEP variants offer proof of concept for the ability to modify the phosphoenol structure to optimize compound properties and performance for PCC.

### Example 3: Process Modeling CO₂ Capture Chemistry in Post-Combustion Capture Systems

State-of-the-art process models of various absorber/stripper architectures in first-generation post-combustion capture (PCC) systems are used to quantify the total thermal energy demand of the CO₂ absorption-desorption process, termed the regeneration energy Q_{reg}. As mentioned previously, Q_{reg} comprises three highly interdependent thermal energy terms, including (1) the sensible heat Qₛₑₙ required to heat the aqueous carbon capture solvent, (2) the latent heat of vaporization Qₗₐₜ for producing steam, and (3) the heat of reaction Qᵣₓₙ for desorption of CO₂.

$${Q}_{reg} = {Q}_{sen} + {Q}_{lat} + {Q}_{rxn}$$

The most common objective of PCC process modeling is to minimize Q_{reg} by varying either process parameters, like solvent flow rate, stripper pressure and reboiler temperature, or solvent parameters, like CO₂ vapor-liquid equilibrium (VLE), reaction enthalpy ΔHᵣₓₙ and mass transfer properties. A typical absorber/stripper configuration is shown in a system 100 in FIG. 21. Similar to the system 10 shown in FIG. 2, the system 100 of FIG. 21 includes an absorber 102, a stripper 104, a heat exchanger 106, as well as a reboiler 108.

Counterpropagating flows of CO₂-rich flue gas (1_{(g)}), entering from the bottom of the absorber 102, and CO₂-lean aqueous solutions of the carbon capture compound (1_{(liq,c)}), entering from the top of the absorber 102, mix and CO₂ is transferred from the flue gas to the solution via dissolution into the aqueous phase, dissociation to the bicarbonate ion and reversible reaction with the carbon capture compound, typically referred to as the solvent. The CO₂-rich solvent (2_{(liq, c)}) collected at the bottom of the absorber 102 is pumped through a heat exchanger 106 and thermal energy of the hot CO₂-lean solvent on the return cycle (4(_{liq,h})) from the stripper is transferred to the CO₂-rich solvent which is then sent to the top stage of the stripper 104 (3_{(liq,h)}).

The gas not absorbed by the solvent exits the absorber 102 (2_{(g)}) and can be released to the atmosphere; such gas can include N2, H2O, etc.

Counterpropagating flows of steam from the reboiler 108 at the bottom of the stripper 104 and CO₂-rich solvent from the top (3_{(liq,h)}) mix and CO₂ is transferred or released from the aqueous phase to the vapor phase via a thermally driven reverse of the carbon capture reaction. Gaseous CO₂ then exits the top (3_{(g)}) of the stripper 104 to a compressor 110; the compressed gas can then be stored (for example, geologic storage). The CO₂-lean solvent collects at the stripper bottom (4_{(liq,h)}) and is recycled through the heat exchanger 106, transferring its thermal energy to the CO₂-rich solvent, and then fed back to the top of absorber 102.

Process modeling studies to date have shown that operational variables—solvent flow rate and stripper pressure and temperature—are constrained in their degrees of freedom to influence the regeneration energy. One variable must be set to satisfy operational targets (e.g., 90% capture efficiency) while the others are limited by the chemical stability of the carbon capture compound. Therefore, it is widely recognized that the solvent is the most critical variable in minimizing Q_{reg}. Much effort has been made to quantify optimal solvent properties, but these studies have exclusively focused on various amines and amine mixtures. There has been no effort to study alternative, non-amine carbon capture chemistry. In the current work, well established state-of-the-art process models within the Aspen Plus architecture were used to study phosphoenol-based CO₂ capture chemistry starting with the base PEP molecule.

### Example 4: Another ReaxFF Model and Simulations

This example presents a second ReaxFF model developed to describe the CAM reactions involving PEP and the atomic interactions in the P/C/O/H system. The ReaxFF force field parameters were fitted against quantum mechanical (QM) training data for partial charges, molecular structures, bond dissociation energies, reaction energies and activation energies. Second generation water parameters were combined with P/C parameters for more accurate water description and P's electrostatic parameters were specially treated to correct P/O interactions. This developed P/C/O/H ReaxFF model was a re-parametrization of the ReaxFF model in Example 2. This model was able to reproduce the training set for structures and energetics of the molecules and reactions involved in the CAM process, and accurately describe the aqueous bicarbonate and PEP systems. Molecular dynamics simulation using this ReaxFF model depicts how bicarbonate reacts with PEP and in solution and determines the impact of local structure on reactions necessary to perform carbon capture using PEP, which enables the potential design of PEP variant as the optimal carbon capture absorbent.

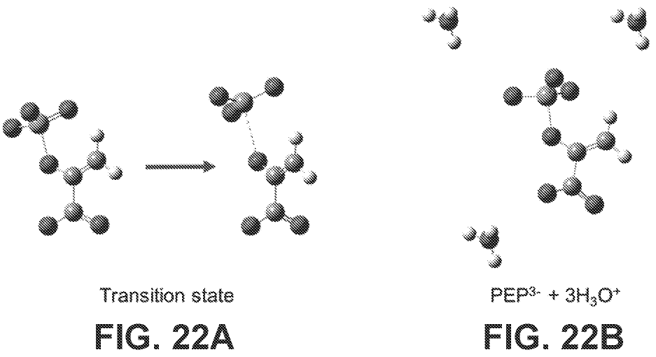

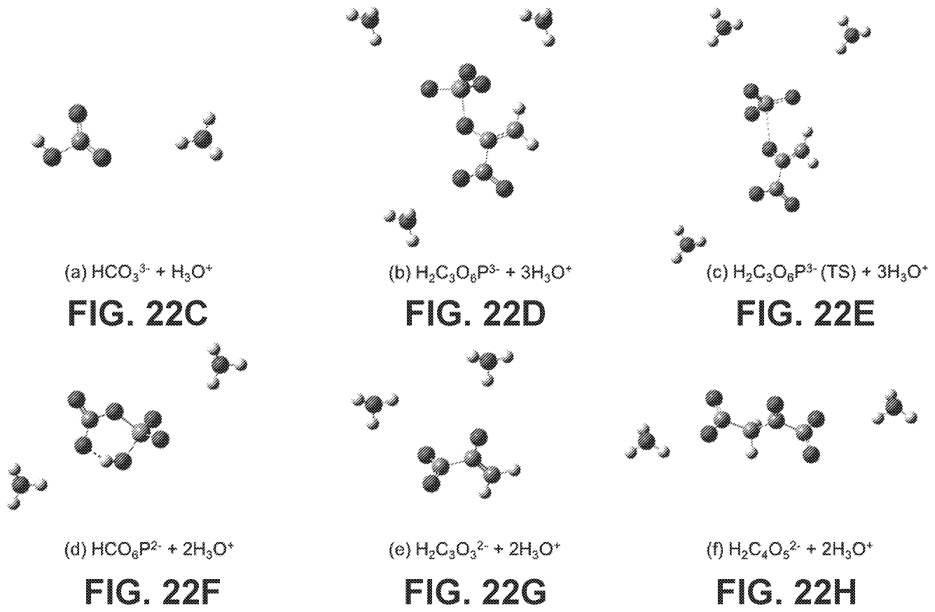

The training set is generally the same as that described above under Example 2. The transition state refers to the reaction where the PO₃²⁻ group dissociates from the charged PEP³⁻, which is shown in FIG. 22A. Since the molecules were all in vacuum for DFT calculations, and the intermediate species is not stable in vacuum, it was excluded from the training set. Because LAMMPS requires a neutral system, H₃O⁺ were inserted as counter ions. H₃O⁺ were placed at least 4 Å away from the anions to avoid unwanted interactions. FIG. 22B shows an example of such a neutralized system with PEP³⁻. FIGS. 22C-22H show neutralized systems for the other charged molecules used in the training set.

### Force Field Parametrization

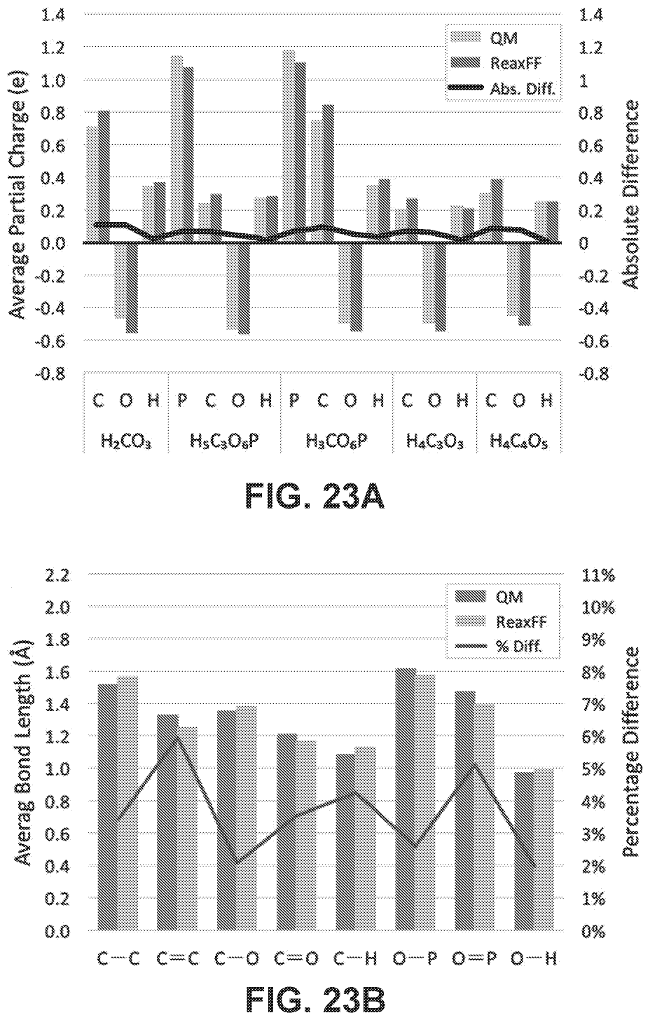

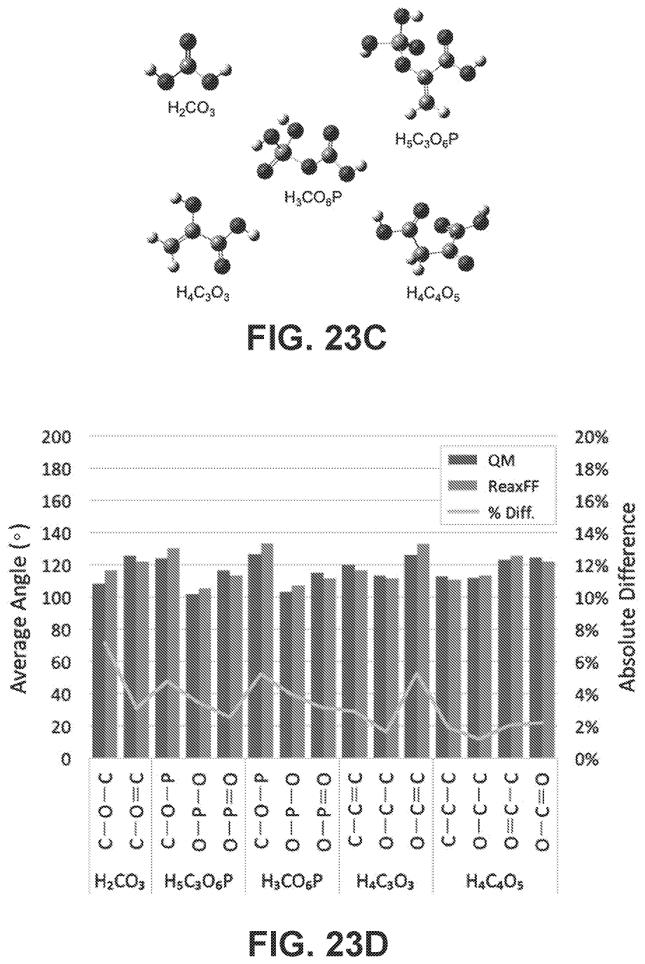

The atomic partial charge errors between the ReaxFF simulations, under this model, and QM calculations are negligible, and the bond and angle errors are all less than 6% and 8%, respectively. FIG. 23A shows average partial charge comparison between ReaxFF and QM for all atoms. FIG. 23B shows average bond length comparison between ReaxFF and QM for all type of bonds. FIG. 23C shows representations of the neutral forms of the molecules. FIG. 23D shows average angle comparison between ReaxFF and QM for bonds around active sites in each molecule.

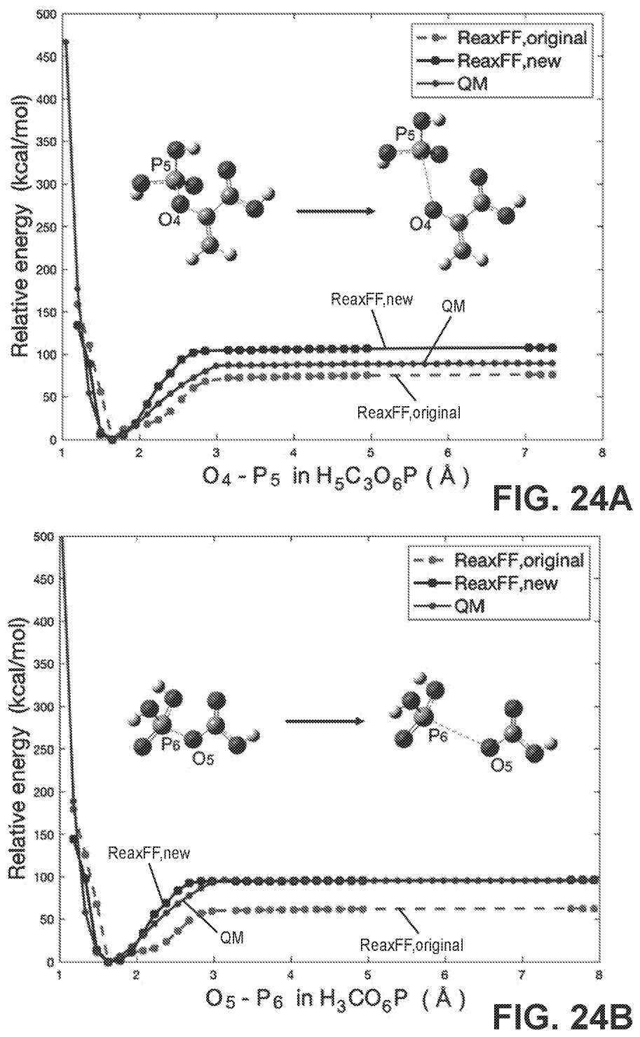

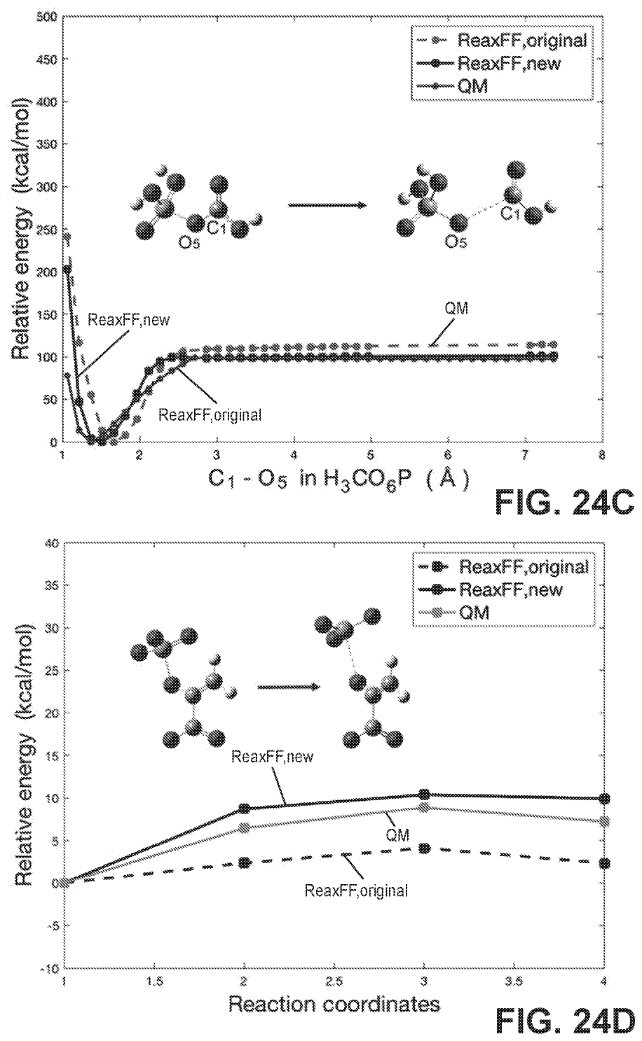

Bond dissociation energy scans are shown in FIGS. 24A-24C and show good agreement with FIGS. 23A-23D. The labels in FIGS. 24A-24D are as follows: “ReaxFF, original” refers to the first ReaxFF model described in Example 2; “ReaxFF, new” refers to the ReaxFF model in this example, and after re-parametrization, relative to the first ReaxFF model; “QM” refers to DFT calculations.

O—P, C—O, and O—H bonds at the active sites for both neutral PEP and neutral carboxyphosphate were scanned from very short to equilibrium distances and then to very large distances without relaxing the whole structure, and the energies along the scans were acquired. To account for the multiple spin states as the molecules break, both singlet and triplet scans were calculated, and the lower energies were taken. Some energy data points at far distances were removed to reduce computational cost. The structures corresponding to each DFT data point along the scans were then fed to ReaxFF MD simulations to calculate ReaxFF energies. The fitted ReaxFF energies generally match the DFT energies, especially at the regions near the equilibrium distances, and the performance of the force field for the model under this example improved, compared to the original ReaxFF model of Example 2.

FIG. 24D shows the comparison of the energies along the reaction pathway and the reaction energy between DFT (B3LYP/6311++g(d,p)) and ReaxFF. The energies along the reaction pathway were obtained from intrinsic reaction coordinate (IRC) calculation using DFT, and the ReaxFF energies were fitted using for the structures along the DFT IRC curve. The barrier energy from DFT and ReaxFF are 8.87 kcal/mol and 7.08 kcal/mol, respectively, and the reaction energy from DFT and ReaxFF are −16.90 kcal/mol and −12.84 kcal/mol, respectively. Both the barrier energy and the reaction energy prove that the optimized force field can well describe the kinetics and thermodynamics of the reaction.

### Solution Validation

Diffusion coefficients and radial distribution functions (RDFs) were also calculated and compared with literature values (38) using non-reactive MD simulations to characterize HCO₃⁻, and PEP³⁻ in water. Diffusion coefficients were obtained by fitting to the mean square displacement (MSD) over the time interval where MSD increased linearly. The diffusion coefficient of HCO₃⁻ at 298 K in published literature was 1.17×10⁻⁹ m²s⁻¹, and the diffusion coefficient of HCO₃⁻ at 298 K in this ReaxFF fitted system was 0.67×10⁻⁹ m²s⁻¹. Because both calculations were performed on one HCO₃⁻ in water, a statistical error was expected, and the discrepancy between the two diffusion coefficients were acceptable particularly as this ReaxFF model was not optimized for dynamics.

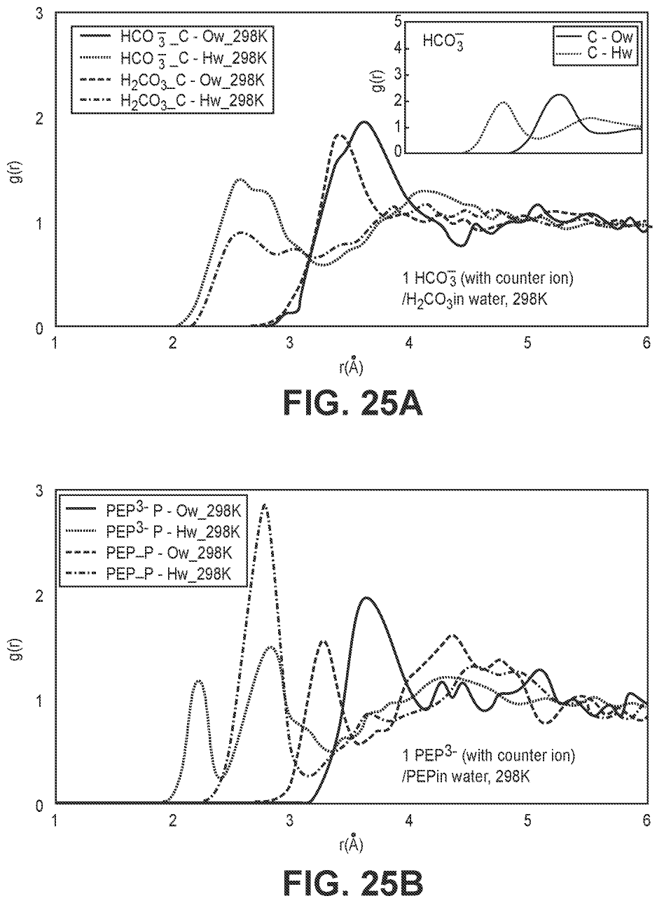

The RDF of HCO₃⁻ was calculated both in the published literature and in this ReaxFF system. The first peak of the RDF between the carbon in HCO₃⁻ and the oxygen in H₂O was around 3.65 Å in the ReaxFF system whereas between carbon in HCO₃⁻ and hydrogen in H₂O around 2.57 Å in the ReaxFF fitted system. Both matched with quantitatively. In addition, the RDFs of H₂CO₃, PEP³⁻ and PEP were also calculated. Diffusion coefficients and RDFs compared between the non-reactive MD simulations in the published literature and this ReaxFF model show that the model not only correctly describes vacuum properties but also solution structure and dynamics. See FIGS. 25A and 25B.

### Analysis and Prediction

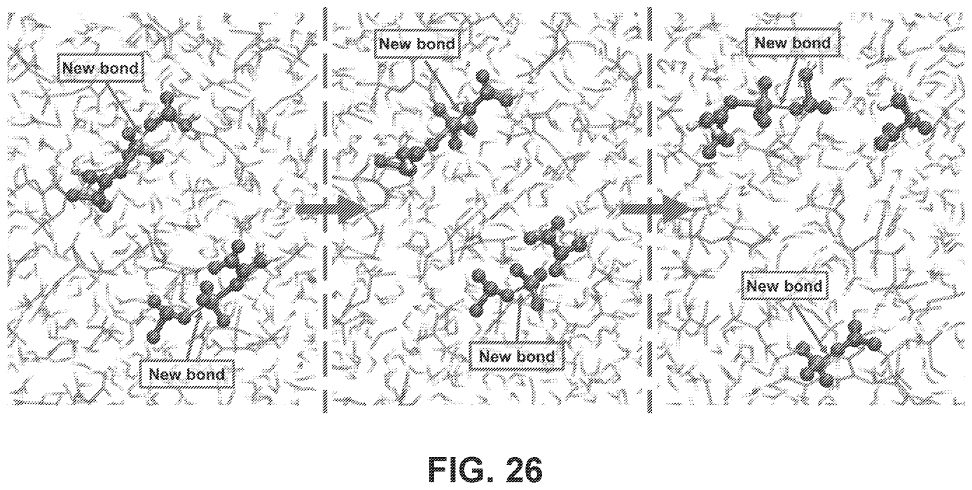

After optimization and initial validation (see above) long simulations were performed for 30 wt % PEP in water with bicarbonate using this ReaxFF model ff.P/C/O/H. Depending on the initial configuration, the reaction can sometimes proceed easily. The local structure is important for reaction progress. In one case, as shown in FIG. 26, two intermediate species were formed, weakening the two P—O bonds where the oxygens connect to the carbons. One of the intermediate species then dissociates into an enolate form of pyruvate and a carboxyphosphate, which then diffuse away from each other, making both the enolate form of pyruvate and the carboxyphosphate stable. These reactions match with the expected reactions, showing that this ReaxFF model predict the correct reactions without need for biasing.

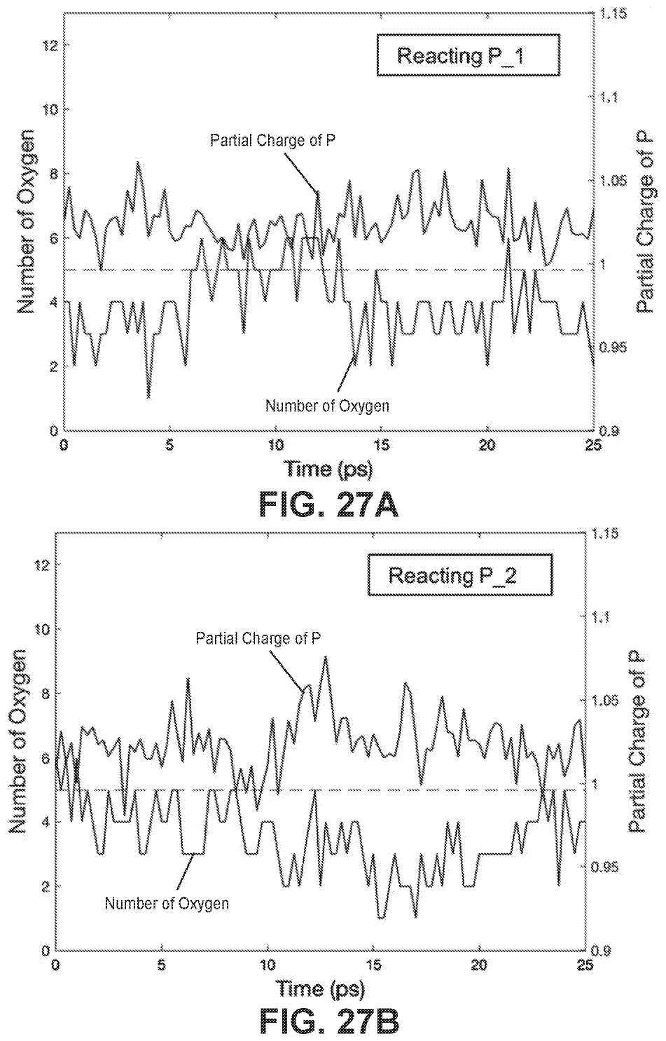

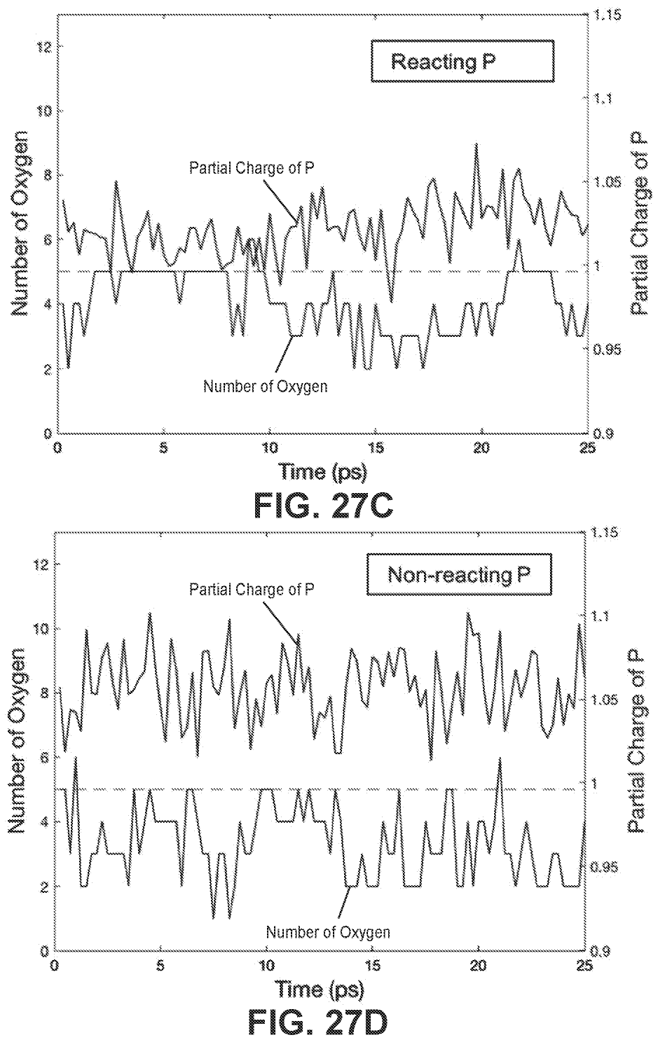

The correlation between the partial charges and the reaction was also analyzed. For the system where two PEP-bicarbonate pairs reacted, the partial charge and the coordination number of P in the reacting PEPs were recorded over 25 ps, as shown in FIGS. 27A and 27B. The coordination number of P in stable PEP was 4, but when the PEP reacted with a bicarbonate to form the intermediate, the P connected with an oxygen from the bicarbonate raising its coordination number to 5. (The dashed line in FIGS. 27A-27D corresponds to coordination number equal to 5.) It was observed that the partial charge of the P in the reacting PEP was negatively correlated with the coordination number. The P in the reacting PEP has lower partial charge when it bonded to the O in the bicarbonate.

In another run where only one PEP-bicarbonate pairs reacted, the partial charge and coordinate number of that P were recorded, and those of the P in 10 randomly chosen non-reacting PEPs were also recorded for comparison. See FIGS. 27C and 27D. It was observed that the P in non-reacting PEPs generally had higher partial charges than in the reacting PEP, and in the non-reacting PEPs, the partial charge of the P did not have any correlation with the coordination number of the Ps. Therefore, if the PEP reacts with its neighboring bicarbonate, the partial charge of its P tends to be lowered and is negatively correlated with its coordination number.

In summary, this ReaxFF model ff.P/C/O/H for biomimetic carbon capture potentially uses PEP as a substitute for MEA. During the force field parametrization, it was found that the phosphorous' EEM parameters have some intrinsic problems that needed to be treated. This ReaxFF model was able to correctly predict vacuum properties of the molecules and reaction related to the target carbon capture chemistries, as well as solution properties. This ReaxFF model also correctly predicted the target reactions during MD simulations, where bicarbonates react with PEPs in solution to form the intermediate species and then dissociate into the carboxyphosphate and enolate form of pyruvate. It was also observed that if the PEP reacts with its neighboring bicarbonate, the partial charge of its P tends to be lowered and is negatively correlated with its coordination number. Thus, this ReaxFF model can determine the impact of local structure on reactions necessary to perform carbon capture using PEP. This will enable selection of optimal reaction conditions and design of new PEP variants that are more reactive with bicarbonate, more stable after reaction, and possibly more energy efficient.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated.

Although the description above contains much specificity, these specific examples should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

The scope of this disclosure should be determined by the appended claims and their legal equivalents. Therefore, it will be appreciated that the scope of the present disclosure fully encompasses other embodiments which may be recognized as equivalent to those skilled in the art. All structural, chemical, and functional equivalents to the elements of the above-described preferred embodiment that are known to those of ordinary skill in the art are expressly incorporated herein by reference and are intended to be encompassed by the present claims.

Reference to an element in the singular is not intended to mean “one and only one” unless explicitly so stated, but rather “one or more.” Moreover, it is not necessary for a device or method to address each and every problem sought to be solved by the present disclosure, for it to be encompassed by the present claims. No element, component, or method step in the present disclosure is intended to be dedicated to the public regardless of whether the element, component, or method step is explicitly recited in the claims.

1. An absorbent compound for capturing carbon dioxide (CO₂) having a chemical structure represented by Formula I 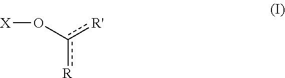
wherein [symbol] is a double or single bond;
X is a phosphono, —[PO₃H]⁻ or —[PO₃]²⁻ group, a sulfo or —[SO₃]⁻ group, or a nitro group; and
R and R′ are independently selected from the group consisting of hydrogen, a halogen, a hydroxyl group, an oxo group, an optionally substituted alkyl group, an optionally substituted cycloalkyl group, an optionally substituted alkenyl group, an optionally substituted aryl group, a heterocyclic group, an acyl group, a carboxyl group, a carboxylate group, alkoxy group, an aryloxy group, an alkylsulfonyl group, an arylsulfonyl group, and combinations thereof, or a salt thereof, with the proviso that at least one of R and R′ has an ion or is ionizable and the compound is not phosphoenolpyruvic acid, phosphoenolpyruvate, sulfoenolpyruvic acid, or sulfoenolpyruvate, or a salt thereof.

2. The compound of claim 1, wherein R is CH₂ and R′ includes an alkene, an alkyne, or an aryl group, or R is a methyl group and R′ is a carboxylate group.

3. The compound of claim 1, wherein X is a phosphono, —[PO₃H]⁻ or —[PO₃]²⁻ group, a sulfo or —[SO₃]⁻ group.

4. The compound of claim 1, wherein R′ is a carboxyl group or a carboxylate group and R is a hydrogen, a hydroxyl group, an oxo group, a carboxyl group or a carboxylate group, optionally the compound is phosphoenol-buten(3,4)one, phosphoenol-3-methylene-but-1-ynone, phosphoenol-keto-ethenyl-benzene, or phosphoenol-2-oxo-hex(4,5)enoate.

5. The compound of claim 1, wherein R is (CHₐY_{b})_{d}, where a is 2, 1 or 0, b is 1 or 0, and b+a<2, Y is selected from OH, CHOH C(═O)OH, O, CH₂, CHCH₃; and d is from 1 to 6, with the proviso that if R is CH₂, R′ is not carboxylate; optionally the compound is 2-hydroxy-2(phosphonooxy)acetic acid, 2-(phosphonooxy)acetic acid, 2-(phosphonooxy)malonic acid, 2-oxo-2-(phosphonooxy)acetic acid or (E)-3-hydroxy-2-(phosphonooxy)acrylic acid.

6. A CO₂ capture composition comprising the absorbent compound of claim 1 and a carrier, vehicle, diluent or solid support.

7. The composition of claim 6 comprising about 0.1% to 90% or about 0.5% to 60%, by weight of the absorbent compound of Formula I, optionally at least 25% by weight the absorbent compound, such as about 30% to about 60% by weight, about 35% to about 55% by weight, or about 40% to about 50% by weight.

8. The composition of claim 6 comprising a liquid carrier, vehicle or diluent selected from the group consisting of water, saline, buffered solutions, hydroalcoholic mixtures, and alcohols.

9. A method of capturing carbon dioxide (CO₂) from a gas stream containing CO₂, the method comprising:
contacting a CO₂-containing gas stream with an absorbent, the absorbent reversibly reacting with CO₂ in a reaction to capture CO₂ from the gas stream,
wherein the absorbent includes a compound having a chemical structure represented by Formula I: 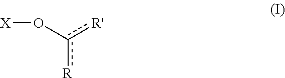
wherein [symbol] is a double or single bond;
X is a phosphono, —[PO₃H]⁻ or —[PO₃]²⁻ group, a sulfo or —[SO₃]⁻), or a nitro group; and
R and R′ are independently selected from the group consisting of hydrogen, a halogen, a hydroxyl group, an oxo group, an optionally substituted alkyl group, an optionally substituted cycloalkyl group, an optionally substituted alkenyl group, an optionally substituted aryl group, a heterocyclic group, an acyl group, a carboxyl group, a carboxylate group, alkoxy group, an aryloxy group, an alkylsulfonyl group, an arylsulfonyl group, and combinations thereof, or a salt thereof, with the proviso that at least one of R and R′ has an ion or is ionizable and the compound is not phosphenolpyruvic acid, phosphoenolpyruvate, sulfoenolpyruvic acid or sulfoenolpyruvate, or a salt thereof.

10. The method of claim 9 further comprising:
releasing the captured CO₂ from the absorbent via a stripping process.

11. The method of claim 10, wherein releasing the captured CO₂ is performed by reversing the reaction of the absorbent and CO₂.

12. The method of claim 10, wherein releasing the captured CO₂ is performed in the absence of enzymes.

13. The method of claim 10, wherein the stripping process is performed by a stripper and operating the stripper includes at least one of: increasing an operating temperature inside the stripper, decreasing the operating temperature inside the stripper, increasing an operating pressure inside the stripper, and decreasing the operating pressure inside the stripper.

14. The method of claim 13 further comprising:
increasing a temperature of the CO₂-containing absorbent, after the capturing step and prior to the releasing step, using heat from the absorbent after the absorbent exits the stripper.

15. A device for capturing carbon dioxide (CO₂) from a gas stream containing CO₂, the device comprising:
an absorbent; and
an absorber comprising:
a gas inlet to receive a gas stream for circulation through the absorber, the gas stream containing CO₂;
an absorbent inlet to receive the absorbent for circulation through the absorber, the absorbent selectively and reversibly reacting with CO₂ inside the absorber to capture the CO₂ and form a CO₂-containing absorbent;
a gas outlet for exit of the gas stream from the absorber; and
an absorbent outlet for exit of the CO₂-containing absorbent from the absorber;
wherein the absorbent includes a compound having a chemical structure represented by Formula I: 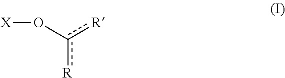
wherein [symbol] is a double or single bond;
X is a phosphono, —[PO₃H]⁻ or —[PO₃]²⁻ group, a sulfo or —[SO₃]⁻), or a nitro group; and
R and R′ are independently selected from the group consisting of hydrogen, a halogen, a hydroxyl group, an oxo group, an optionally substituted alkyl group, an optionally substituted cycloalkyl group, an optionally substituted alkenyl group, an optionally substituted aryl group, a heterocyclic group, an acyl group, a carboxyl group, a carboxylate group, alkoxy group, an aryloxy group, an alkylsulfonyl group, an arylsulfonyl group, and combinations thereof, or a salt thereof, with the proviso that at least one of R and R′ has an ion or is ionizable and the compound is not phosphoenolpyruvic acid, phosphoenolpyruvate, sulfoenolpyruvic acid or sulfoenolpyruvate, or a salt thereof.

16. The device of claim 15, wherein the wherein R is CH₂ and R′ is an alkene, an alkyne, or a aryl group, or R is a methyl group and R′ is a carboxylate group, and optionally X is a phosphono or sulfo group, or a conjugated base thereof, R′ is a carboxyl group or a carboxylate group and R is a hydrogen, a hydroxyl group, an oxo group, a carboxyl group or a carboxylate group, optionally the absorbent includes phosphoenol-buten(3,4)one, phosphoenol-3-methylene-but-1-ynone, phosphoenol-keto-ethenyl-benzene, or phosphoenol-2-oxo-hex(4,5)enoate.

17. The device of claim 15, wherein R is (CHₐY_{b})_{d}, where a is 2, 1 or 0, b is 1 or 0, and b+a<2, Y is selected from OH, CHOH C(═O)OH, O, CH₂, CHCH₃; and d is from 1 to 6, with the proviso that if R is CH₂, R′ is not carboxylate; optionally the absorbent includes 2-hydroxy-2(phosphonooxy)acetic acid, 2-(phosphonooxy)acetic acid, 2-(phosphonooxy)malonic acid, 2-oxo-2-(phosphonooxy)acetic acid or (E)-3-hydroxy-2-(phosphonooxy)acrylic acid.

18. The device of claim 15, wherein the absorbent comprises a carrier, vehicle, or diluent selected from the group consisting of water, saline, buffered solutions, hydroalcoholic mixtures, and alcohols.

19. A system comprising the device of claim 15, the system further comprising:
a stripper configured to receive steam and the CO₂-containing absorbent to reverse the reaction between CO₂ and the absorbent thereby releasing CO₂ from the absorbent,
wherein the absorbent can be recirculated back to the absorber for re-use.

20. The system of claim 19 further comprising:
a heat exchanger configured to circulate the absorbent exiting the stripper and the CO₂-containing absorbent exiting the absorber,
wherein the absorbent exiting the stripper rejects heat to the CO₂-containing absorbent.

21. (canceled)
